(19) United States
(12) Patent Application Publication
(10) Pub. No.: US 2004/0173948 A1
(43) Pub. Date: Sep. 9, 2004

(54) Process and apparatus for silicon boat, silicon tubing and other silicon based member fabrication

(76) Inventor: Kiril A. Pandelisev, Mesa, AZ (US)

Correspondence Address: James C. Wray, Suite 300, 1493 Chain Bridge Road, McLean, VA, 22101, US

(21) Appl. No.: 10/804,152

(22) Filed: Mar. 19, 2004

(30) Foreign Application Priority Data
Sep. 19, 2002 (WO) PCT/US02/29516

(51) Int. Cl. B29C 43/00

(52) U.S. Cl. 264/500; 264/109

(57) ABSTRACT

Process, apparatus and application of silicon/silicon alloy/silicon compound comprising at least one silicon atom boat, silicon/silicon alloy/silicon compound comprising at least one silicon atom made epitaxial chamber and various silicon/silicon alloy/silicon compound comprising at least one silicon atom made tubing and liners is described here. Powder pressing, plasma and non plasma powder deposition, slurry deposition and slurry casting, silicon/silicon alloy casting and directional solidification are among few methods described here. Silicon/silicon alloy made articles and some of their applications in the wafer processing industry is also described.

### BACKGROUND OF THE INVENTION

Wafer Boats and wafer holders made from high purity quartz, fused silica or silicon carbide are being used in silicon and other wafer processing. Some processing is done in quartz-lined stainless steel chambers. As the device size becomes smaller the mismatch between the thermal properties of the silicon wafer, the wafer boat housing the wafer during various chemical and thermal treatments and the chamber housing the boat with the wafers becomes a problem.

Particulates are created and the stress imposed on the wafer during various processing steps affects the yield of the process. New approach to the process environment is needed.

### SUMMARY OF THE INVENTION

High purity quartz or fused silica is used as material for various epitaxial reactors, CVD chambers, CVD chamber liners and/or tubing for processing the wafers. Silicon boats made from single crystalline silicon only will not have the desired mechanical properties. Single crystal silicon considerably softens at 400° C. and makes it not suitable for many high temperature applications. The present invention provides a solution to those and other problems.

Process and apparatus for various approaches for making various silicon/silicon alloy members is described below. Forging, extrusion, plasma and hot substrate powder deposition, slurry spray and slurry casting, silicon/silicon alloy casting and directional solidification is described here in more detail. Other methods modified for silicon member fabrication may be used for fabrication of the same.

Silicon/Silicon Alloy Powder Pressing/Forging and Extrusion

Silicon/Silicon Alloy Powder Pressing/Forging and Extrusion may be employed for fabrication of various silicon/silicon alloy members that include, but is not limited to, wafer boats for horizontal and vertical wafer processing furnaces and deposition chambers, epitaxial reactors, lining for CVD, epitaxial reactors and other wafer processing tools, tubing having any form or cross section shape.

Silicon/silicon alloy powder is pressed at room temperature or at an elevated temperature in vacuum or in a controlled atmosphere. Outgassing, removal of oxygen, nitrogen, water vapor and removal of other undesired gases may also be effected before the pressing of the powder. The powder is pressed to a near shape of the part being fabricated, or it may be pressed into a raw material for further processing of the same. The powder consists of silicon, silicon and germanium, silicon and any metal, silicon and silicon carbide, silicon and any ceramic, or silicon and any suitable element or compound.

Silicon powder, silicon based alloys or other suitable silicon or nonsilicon based materials, and/or composites having the desired grain size is placed in a pressing chamber. The compound may or may not contain silicon alloy. After proper gas treatment and/or vacuuming the residual gas, the powder is pressed. The pressing temperature may be as low as room temperature or as high as the softening point of the lowest melting point constituent. Such pressed part is later on sintered in vacuum or appropriate gaseous atmosphere. Very dense materials having predetermined hardness results from this process. Knowing that the fracture strength is inversely proportional to the grain size (the smaller the grain size the higher the fracture strength) one may tailor various parts for various applications.

Parts made by this process may be machined before the sintering (green part machining). After the sintering process they are expected to yield near shape and they may be used as they are or may be subjected to final machining.

Pressures of up to 800,000 psi or higher may be used for this process. The temperature of the material during pressing and sintering may vary depending on the composition. Temperatures between 300° C. and 1350° C. may be used. Lower than 300° C. and higher than 1350° C. may also be used depending on the material processed and the properties desired.

If press-shaping solid silicon (single crystal or polycrystalline material) into various parts the silicon is heated to the desired temperature for the appropriate plastic properties. The shaping may be done using forging or extrusion of the silicon/silicon alloy or other alloy material.

Pressing and shaping of the material may be done before, during or after the sintering of the material. The plasticity of the material may determine the grain size and the fracture strength of the same. Several steps of hot press process may be employed. For instance, extrusion may be followed by forging and/or high pressure annealing.

The shaping of the material may be used for imbedding stronger material in the part itself for reinforcement purposes. The strong layer may be within the part or may constitute the outer or inner surface of the part. Parts having desired strength pattern may be made by this method.

Powder Deposition

Plasma heated silicon grain is introduced in a chamber that may be a vacuum, low pressure, normal pressure, medium pressure, or high-pressure chamber. The so heated powder is directed towards heated substrate and deposited. The powder deposition may consist of silicon only, or silicon and other material particles that might reinforce the silicon structure without changing the chemical behavior or material particles that change the properties of silicon and form a silicon alloy or solid solution that may or may not contain any silicon. Ge, SiₓG₁₋ₓ, SiC, other silicon based materials or ceramics or other suitable elements or compounds that contain no silicon or silicon alloys may be used for doping, reinforcement purposes or as main materials for the part being made. Depending on the temperature of the substrate, the deposited layers may have different densities and thicknesses which after sintering results in very dense material having desired fracture strengths.

Non-plasma heated powder or not heated powder may be injected in the chamber and directed towards a hot substrate within heated or non-heated controlled atmosphere or vacuum chamber. The powder grain is heated to the desired temperature on its way to the substrate and from the hot substrate. Such heated grain adheres to the substrate and/or other previously deposited grains. The density of the deposited body depends greatly on the grain size, grain temperature at impact and the substrate temperature.

The silicon/silicon alloy/composite member made may have any shape: rod, tube having any cross-section and shape, or any chamber looking type shape where there may be one or more gates. The substrate may be heated up to the softening point of silicon. Optimal temperature is expected to be, but not limited to, between 800° C. to 1350° C. Temperatures less than 800° C. and more than 1350° C. may also be applied.

The sintering of the silicon/silicon alloy/composite members may be done in situ, or after they have been machined, shaped or joined with other parts made by the same or different process. The sintering temperature will greatly depend on the chemical composition of the parts and their applications.

CVD Deposition

CVD deposition of any type may be used for deposition of silicon and/or silicon and other materials that provides for reinforcement of the deposited layers without changing the chemical behavior of the surface of interest. The silicon/silicon alloy/composite layers may be on suitable substrate that has sticking coefficient to the deposited material. Silicon nitrides, graphite, metal silicates, some ceramics such as SiC and other combinations may be suitable as substrate for particular applications.

The temperature of the substrate as well as the pressure of the deposition process may vary depending on the method used. So deposited layers may have initial thickness that after sintering results in very dense material having desired thickness for a particular application. Silicon/silicon alloy/composite members having shape of rod, tube having desired cross-section shape and size, plate or any wafer processing chamber suitable type shape may be made. There might be one or more gates leading inside the chamber.

Slurry Method and Apparatus

Mixing the powder with a high purity liquid chemical compound and forming a slurry for spraying or casting of desired body may be also be employed. In case of spraying, the slurry is deposited on a substrate that may rotate or translate. The substrate may be any material that does not react with or contaminate the slurry and that can either be incorporated in the product made or it can be separated after the removal of the liquid by curing during or after the deposition of the slurry. Such cured articles can be roughly machined before the bake-out process. A bake out process is employed to completely remove the chemical substance (binder) and to sinter the silicon/silicon alloy/composite powder made member. Machining of these parts into desired shapes follows the bake-out process.

The slurry deposition and/or casting may be conducted in vacuum or controlled gas atmosphere chamber employing one or more heaters. The curing and sintering may be conducted in the same or in a different chamber.

Silicon/silicon alloy members having shapes of rod, round tube, rectangular tube, plate or any wafer processing chamber suitable type shape may be made by this approach.

Casting

Casting to shape of silicon/silicon alloy/composite grain or re-melting and casting solid silicon may be used for forming various alloy made parts. A high purity mold made from easily removable material that does not react with silicon/silicon alloy/composite is filled with shot, powder or small chunks of the material to be processed. The material used for casting may be melted in a separate container and transferred into the mold after melting. All appropriate steps for removal of the oxygen, nitrogen, water vapor, and other possible contaminants are taken before the processing takes place. The silicon/silicon alloy/composite member made may have any shape: rod, round tube, tube or any other shape or form.

Gelcasting of Silicon/Silicon Alloy/Composite Material Members

During gelcasting the Silicon/Silicon Alloy/Composite Material the material is first converted in powder having desired grain size. The powder is suspended in a monomer solution which is polymerized in a mold to form a rigid polymer/solvent gel. Organic or inorganic substances might be added to the powder/polymer binder to trigger the polymerization process at desired process conditions such as temperature, viscosity, etc. The system may contain up to 10-20 weight % polymer. This percentage may be as low as few weight percent and may be over 20 weight percent. The solvent portion is removed by drying step after the part is removed from the mold.

The solution may be aqueous or non-aqueous. Typical non-aqueous solution might contain 50-55 volume % of powder with the balance being the dispersion solution. The solution may have about 10% dispersant such as Rohm & Haas Triton X-100, or N-100 Dupont dibasic ester (DBE) or ICI Americas Solsperse 2000 in dibutil phtalate (DBP) and 90% gelcasting premix. The premix might include 10-30 volume % of monomers such as trifunctional trimethilpropane triacrylate (TMPTA) and difunctional 1,6 hexanediol diacrilate (HDODA) both from Hoechst Celanese, 0.5 to 10 volume % of dybenzoil peroxide initiator with the rest being either DBA, DBP or other suitable solvent.

The member fabrication may be done by hardening of the mass in a mold, by spraying onto a substrate having desired process temperature. The spraying might be vacuum or desired gaseous atmosphere. The spraying method may consist of spraying the slurry or spraying the various components onto the substrate where they mix, react and harden into the desired shape.

The member fabrication may be by continuous feed onto a beltline type apparatus. Hardening, drying and even sintering may be part of the continuous process. The feed may consist of already made mixture, or mixing it at the feeding point.

Directional Solidification

Fabrication of large size silicon/silicon alloys/composite in a plate, rod, tube or any other shape might be made economical by the use of directional solidification. The process may be carried out in an open or closed mold/container containing the material to be solidified. The process may be conducted in a vacuum or controlled atmosphere chamber. All appropriate steps for removal of oxygen, nitrogen, water vapor, and other possible contaminants are taken before the processing takes place. The member made may have any shape: plate, rod, tube or any other shape or form.

These and further and other objects and features of the invention are apparent in the disclosure, which includes the above and ongoing written specification, with the claims and the drawings.

### BRIEF DESCRIPTION OF THE DRAWINGS

FIG. 1. Reshaping/Forging silicon/silicon alloy/composite material.

FIG. 2. High temperature vacuum/special gas atmosphere reshaping/forging silicon/silicon alloy/composite material.

FIG. 3. Extrusion Apparatus with refill hopper.

FIG. 4. High temperature vacuum/special gas atmosphere extrusion apparatus.

FIG. 5. Material deposition via powder only and/or plasma heated powder spray deposition of silicon/silicon alloy/composite.

FIG. 6. Silicon/silicon alloy/composite slurry deposition

FIG. 7. Directional solidification fabrication of tubing used as a liner or for fabrication of wafer boat.

FIG. 8. Solid and shaped tubing for fabrication of wafer boat.

FIG. 9. Semi fabricated silicon/silicon alloy/composite wafer processing boat.

FIG. 10. Semi fabricated wafer processing boat made from structurally reinforced silicon/silicon alloy/composite material.

FIG. 11. Cross section of the base material for wafer processing boat made from structurally reinforced silicon/silicon alloy/composite material.

FIG. 12. Schematic diagram for making tubing and wafer processing fabricates thereof from casting silicon/silicon alloy/composite powder.

FIG. 13. Schematic diagram for making tubing and wafer processing fabricates thereof by cold/hot pressing silicon/silicon alloy/composite powder.

FIG. 14. Schematic diagram for making tubing, plate or rod and wafer processing fabricates thereof from pressing silicon/silicon alloy/composite powder.

FIG. 15. Vertical CVD chamber lined with employing silicon/silicon alloy/composite material employing silicon/silicon alloy/composite wafer boat.

FIG. 16. Multi-chamber wafer processing system employing at least one silicon lined chamber and silicon equipped chamber.

FIG. 17. Top and side view of epitaxial/CVD chamber fabrication process.

FIG. 18. Top view of a multi-chamber wafer processing system employing at least one silicon made chamber and silicon equipped chamber.

FIG. 19. Side view of a multi-chamber epitaxial wafer processing system employing at least one silicon made chamber and silicon equipped chamber.

FIG. 20. Germanium-Silicon phase diagram.

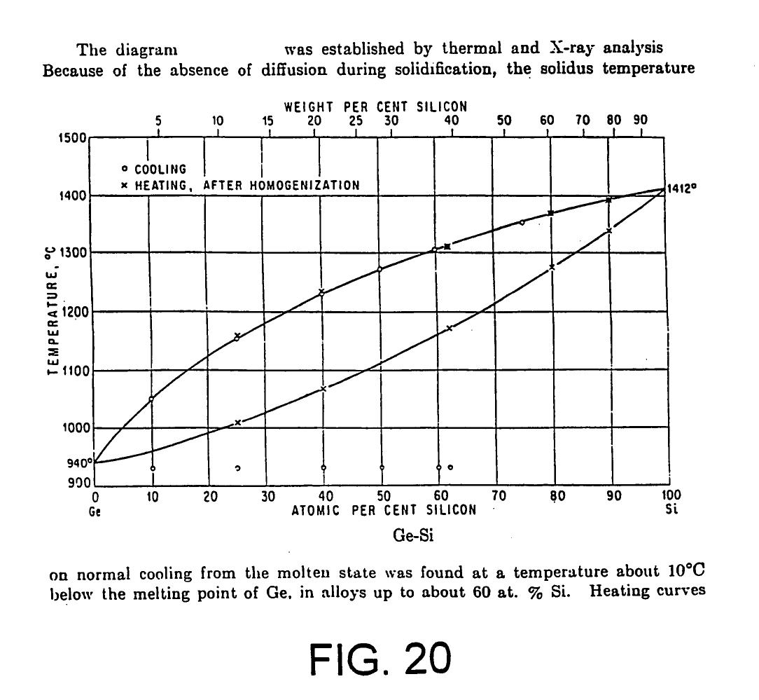

### DETAILED DESCRIPTION OF THE PREFERRED EMBODIMENTS

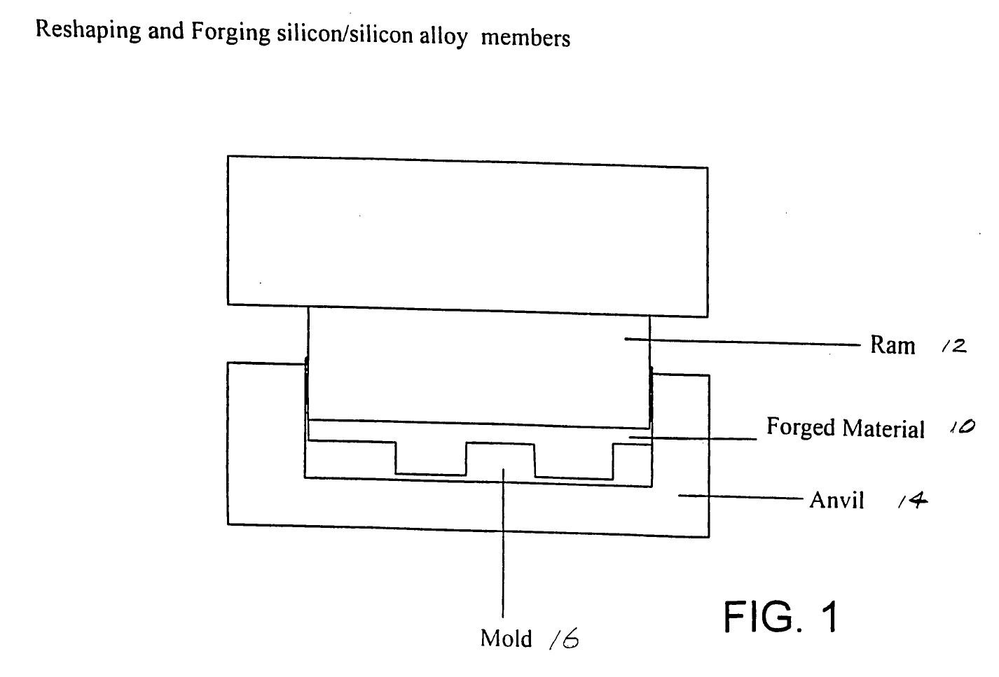

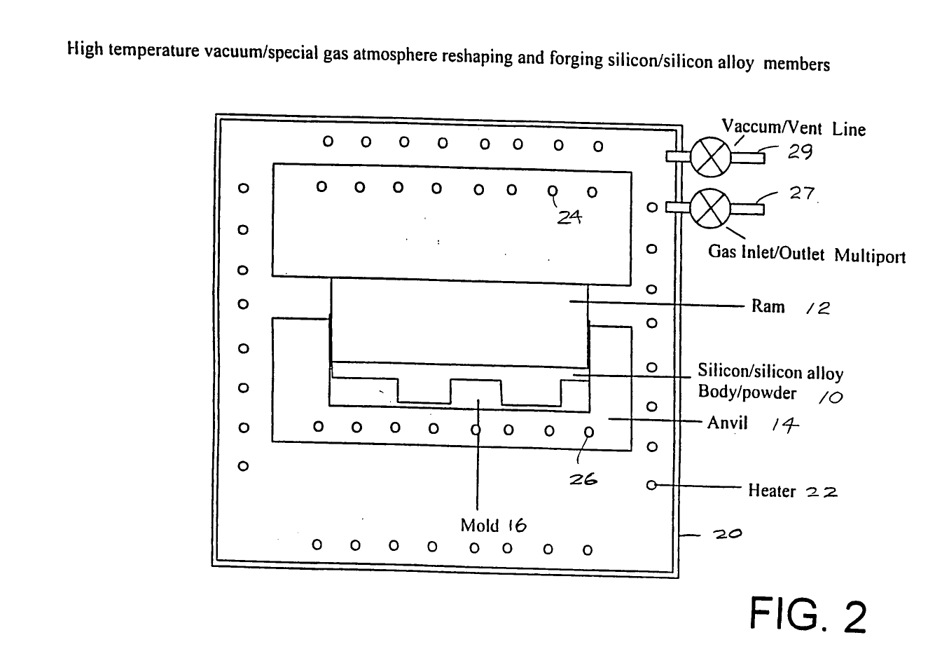

Referring to FIGS. 1 and 2, powder is forged into body 10 with a ram 12, anvil 14 and mold 16. In FIG. 2, heated enclosure 20 has a heater 22, a ram heater 24 and an anvil heater 26. A gas inlet/outlet multiport 27 supplies chamber 20. A vacuum/vent line 29 removes gases.

Forging the monocrystal body uses a temperature between 400° C. and near melting point. The temperature may be less than 400° C. or several degrees less than the melting point of the lowest melting phase in the crystal.

Forging the monocrystal body uses a temperature of 400° C.

Forging the monocrystal body uses a temperature of 600° C.

Forging the monocrystal body uses a temperature of 800° C.

The forged body 10 is polycrystalline material.

The forged body is amorphous material.

The forged body may be composed of single crystalline portion and polycrystalline portion and amorphous portion.

The forging is in vacuum, reduced pressure or inert atmosphere having desired pressure.

The forging is in vacuum, reduced pressure or reactive atmosphere having desired pressure.

The reactive atmosphere in chamber 20 may be plasma, reactive gases or solid and process of purification is administered.

Forging powder for body 10 consists of silicon, silicon and germanium, SiₓGe₁₋ₓ solid solution, silicon and Silicon Carbide Sₓ(SiC)₁₋ₓ, Silicon and silicon dioxide Sₓ(SiO₂)₁₋ₓ, silicon and any ceramic, silicon and any oxide Sₓ(Oxide)₁₋ₓ, silicon and any metal SiₓM₁₋ₓ, Silicon and any alloy SiₓA₁₋ₓ, any combination between themselves at temperature equal or greater than room temperature and lower than the melting point of one or more constituents of the pressed body R_{T}≦T≦T_{M}.

The temperature may be 400° C.≦T≦800° C.

The temperature may be 200° C.≦T≦1000° C.

The temperature may be 200° C.≦T≦1200° C. The temperature may be smaller than 200° C. or greater than 1200° C.

The forging is in vacuum, reduced pressure or inert atmosphere having desired pressure.

The forging is in vacuum, reduced pressure or reactive atmosphere having desired pressure.

The reactive atmosphere may be plasma, reactive gases or solid and process of purification is administered.

The powder may be silicon powder or shot having various grain sizes from sub-micron to rather large shot sizes of several millimeters or larger.

The powder may be silicon powder and germanium powder or shot having various grain sizes from sub-micron to rather large shot sizes of several millimeters or larger.

The powder may be silicon powder and SiₓGe₁₋ₓ (0≦x≦1) powder or shot having various grain sizes from sub-micron to rather large shot sizes of several millimeters or larger.

The powder may be silicon powder and silicon carbide, Sₓ(SiC)₁₋ₓ (0≦x≦1) powder or shot having various grain sizes from sub-micron to rather large-shot sizes of several millimeters or larger.

The powder may be silicon powder and silicon dioxide, Siₓ(SiO₂)₁₋ₓ (0≦x≦1) powder or shot having various grain sizes from sub-micron to rather large shot sizes of several millimeters or larger.

The powder may be silicon powder and metal, SiₓM₁₋ₓ (0≦x≦1) powder or shot having various grain sizes from sub-micron to rather large shot sizes of several millimeters or larger.

The powder may be silicon powder and Sₓ(Alloy)₁₋ₓ (0≦x≦1) powder or shot having various grain sizes from sub-micron to rather large shot sizes of several millimeters or larger.

The powder may be silicon powder and/or metal and/or ceramic and/or alloy and/or oxide and/or any suitable additive powder or shot having various grain sizes from sub-micron to rather large shot sizes of several millimeters or larger.

The powder can be any material suitable for the member fabrication.

The forging apparatus may consist of anvil, mold that contains the forged body and ram.

Each part may be independently heated.

The forging apparatus may be heated from all sides.

The forging apparatus may be enclosed fully or partially in a vacuum, reduced pressure or desired pressure chamber that may be filled with inert, reactive gas or plasma gas.

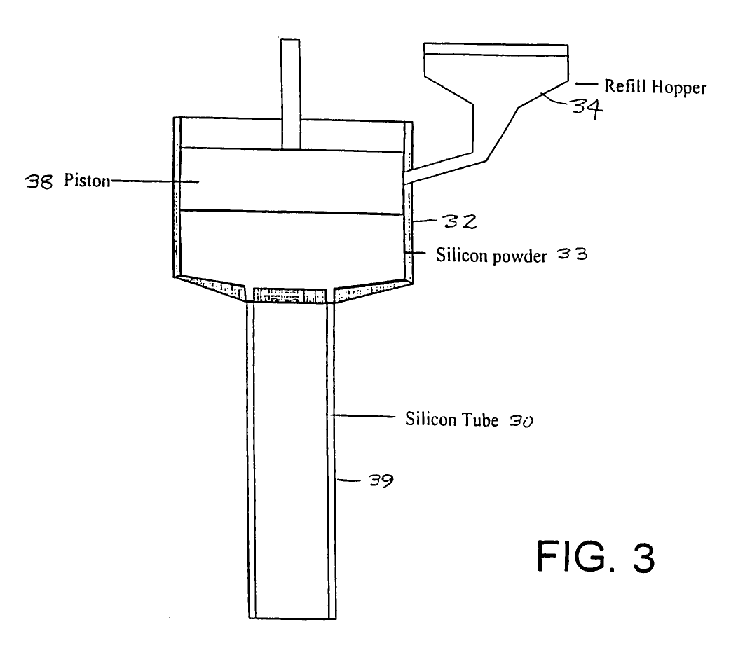

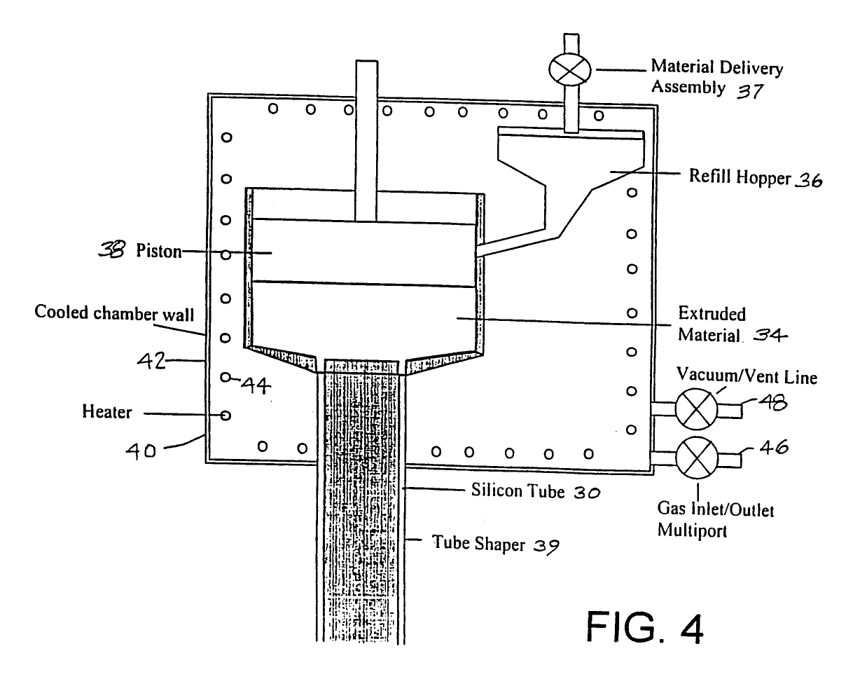

FIGS. 3 and 4 show extruding monocrystal tubular body 30 having a temperature between 400° C. and near melting point. The temperature might be less than 400° C. or several degrees less than the melting point of the lowest melting phase in the crystal.

Extrusion chamber 32 holds silicon powder 33 which becomes extruded material 34 delivered by refill hopper 36 from material delivery assembly 37. The extruded body 30 is forced by piston 38 through a tube shaper 39. A surrounding chamber 40 has a cooled wall 42 and an internal heater 44, a gas inlet/outlet multiport 46 and a vacuum/vent line 48.

The material being extruded may be a single crystal, polycrystalline chunks of material or powder consisting of silicon/silicon alloy/composite material.

Extruding a monocrystal body uses a temperature of 400° C.

Extruding a monocrystal body uses a temperature of 600° C.

Extruding a monocrystal body uses a temperature of 800° C.

The extruded body is polycrystalline material.

The extruded body is amorphous material.

The extruded body may be composed of single crystalline portion and polycrystalline portion and amorphous portion.

The extruding is in vacuum, reduced pressure or inert atmosphere having desired pressure.

The extruding is in vacuum, reduced pressure or reactive atmosphere having desired pressure.

The reactive atmosphere may be plasma, reactive gases or solid and a process of purification is administered.

Extruding powder 33 consists of silicon, silicon and germanium, SiₓGe₁₋ₓ solid solution, silicon and Silicon Carbide Sₓ(SiC)₁₋ₓ, Silicon and silicon dioxide Siₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves at temperature equal or greater than room temperature and lower than the melting point of one or more constituents of the pressed body R_{T}≦T≦T_{M}.

The temperature may be 400° C.≦T≦800° C.

The temperature may be 200° C.≦T≦1000° C.

The temperature may be 200° C.≦T≦1200° C. The temperature may be smaller than 200° C. or greater than 1200° C.

The extruding is in vacuum, reduced pressure or inert atmosphere having desired pressure.

The extruding is in vacuum, reduced pressure or reactive atmosphere having desired pressure.

The reactive atmosphere may be plasma, reactive gases or solid and a process of purification is administered.

The powder may be silicon powder or shot having various grain sizes from sub-micron to rather large shot sizes of several millimeters or larger.

The powder may be silicon powder and germanium powder or shot having various grain sizes from sub-micron to rather large shot sizes of several millimeters or larger.

The powder may be silicon powder and SiₓGe₁₋ₓ (0≦x≦1) powder or shot having various grain sizes from sub-micron to rather large shot sizes of several millimeters or larger.

The powder may be silicon powder and silicon carbide, Siₓ(SiC)₁₋ₓ (0≦x≦1) powder or shot having various grain sizes from sub-micron to rather large shot sizes of several millimeters or larger.

The powder may be silicon powder and silicon dioxide, Siₓ(SiO₂)₁₋ₓ (0≦x≦1) powder or shot having various grain sizes from sub-micron to rather large shot sizes of several millimeters or larger.

The powder may be silicon powder and metal, SiₓM₁₋ₓ (0≦x≦1) powder or shot having various grain sizes from sub-micron to rather large shot sizes of several millimeters or larger.

The powder may be silicon powder and Siₓ(Alloy)₁₋ₓ (0≦x≦1) powder or shot having various grain sizes from sub-micron to rather large shot sizes of several millimeters or larger.

The powder may be silicon powder and/or metal and/or ceramic and/or alloy and/or oxide and/or any suitable additive powder or shot having various grain sizes from sub-micron to rather large shot sizes of several millimeters or larger.

The Extruding apparatus may consist of anvil, mold that contains the forged body and a ram.

Each part may be independently heated.

The extruding apparatus may be heated from all sides.

The extruding apparatus may be enclosed fully or partially in a vacuum, reduced pressure or desired pressure chamber that may be filled with inert, reactive gas or plasma gas.

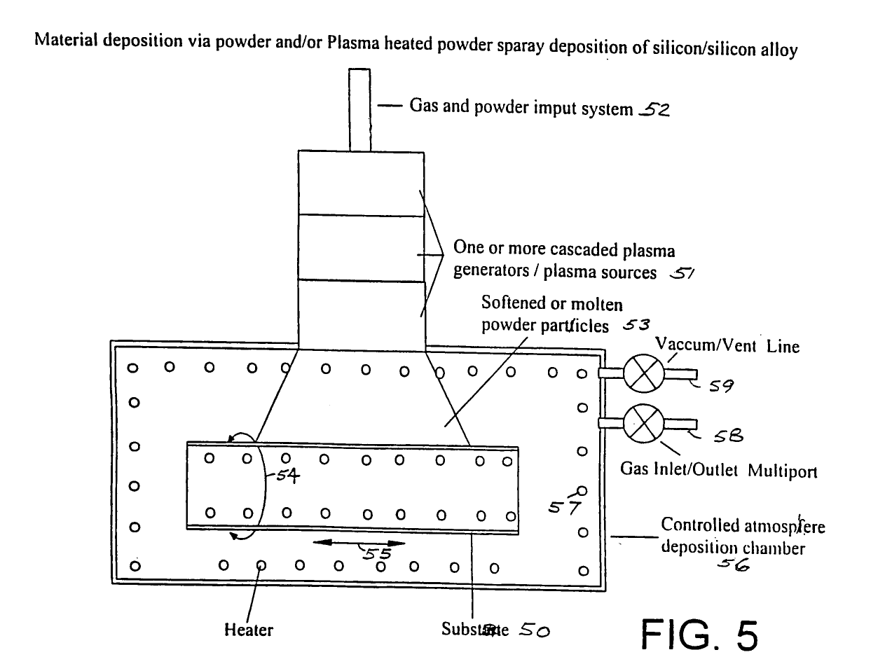

FIG. 5 shows material deposition on a substrate 50, in this case a hollow tube from plasma generators or sources 51 supplied by a gas and powder input system 52. Plasma heated softened particles 53 strike and stick to the substrate and form layers as they are rotated 54 and translated 55. A chamber 56 surrounding the deposition is heated 57. Gas inlet/outlet multiport 58 and vacuum/vent line 59 are connected to the chamber.

Plasma deposition apparatus 59 consists of one or more plasma generators or plasma sources, gas input system, powder input system, vacuum chamber, with or without one or more chamber heating elements, substrate with/out heating elements.

The chamber may have one or more deposition ports.

The substrate may have rotation and/or translation mechanism.

The chamber may have rotation and/or translation mechanisms.

Plasma assisted deposition of powder consisting of silicon, silicon and germanium, SiₓGe₁₋ₓ solid solution, silicon and Silicon Carbide Siₓ(SiC)₁₋ₓ, Silicon and silicon dioxide Siₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves at temperature equal or greater than room temperature and lower than the melting point of one or more constituents of the deposited body R_{T}≦T≦T_{M}.

The deposition process occurs under vacuum, reduced pressure, reactive atmosphere, inert gas, plasma, and any combinations thereof.

The deposition process is in atmosphere having desired pressure.

The reactive atmosphere may be plasma, reactive gases or solid and a process of purification is administered.

The temperature in the chamber may be between temperature equal or greater than room temperature and lower than the melting point of one or more constituents of the deposited body R_{T}≦T≦T_{M}.

The temperature in the chamber may be 400° C.≦T≦800° C.

The temperature in the chamber may be 200° C.≦T≦

The temperature in the chamber may be 200° C.≦T≦1200° C. The temperature may be smaller than 200° C. or greater than 1200° C.

The temperature of the substrate may be between temperature equal or greater than room temperature and lower than the melting point of one or more constituents of the deposited body R_{T}≦T≦T_{M}.

The temperature of the substrate may be 400° C.≦T≦800° C.

The temperature of the substrate may be 200° C.≦T≦1000° C.

The temperature of the substrate may be 200° C.≦T≦1200° C. The temperature may be smaller than 200° C. or greater than 1200° C.

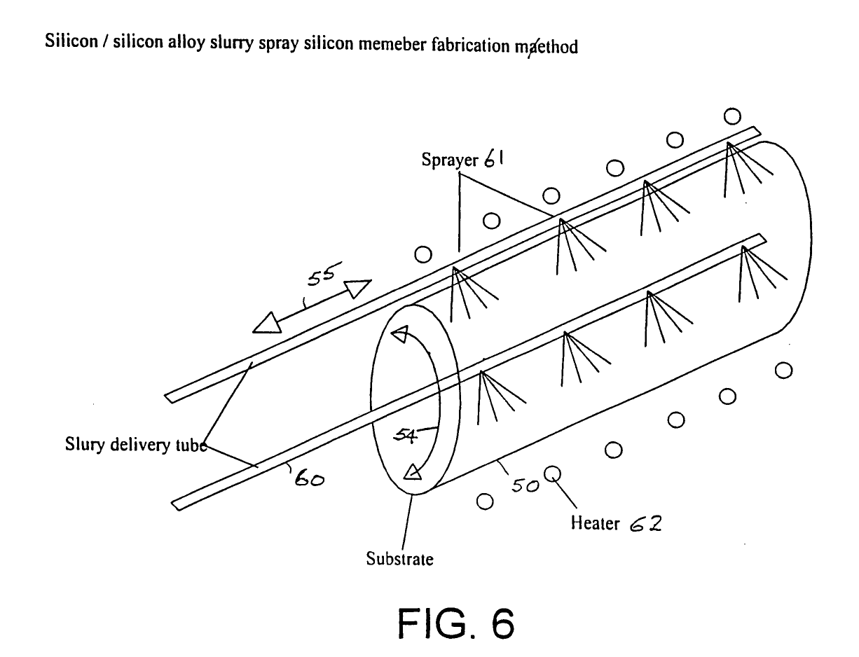

In FIG. 6, substrate 50 is rotated 54. The substrate or slurry delivery tubes 60 translate 55 sprayer 61 spray heated powder which is heated an softened by heaters 62.

Deposition apparatus for spraying of powder, powder and organic or inorganic base material, powder and gaseous material. The powder may consist of silicon, silicon and germanium, SiₓGe₁₋ₓ solid solution, silicon and Silicon Carbide Siₓ(SiC)₁₋ₓ, silicon carbide, silicon nitride, silicon oxynitride, any silicon compound, Silicon and silicon dioxide Siₓ(SiO₂)₁₋ₓ, silicon and any ceramic, silicon and any oxide Siₓ(Oxide)₋ₓ, silicon and any metal SiₓM₁₋ₓ, Silicon and any alloy SiₓA₁₋ₓ, any combination between themselves at temperature equal or greater than room temperature and lower than the melting point of one or more constituents of the deposited body R_{T}≦T≦T_{M}, consisting of a substrate, plurality of sprayers positioned to spray at least one portion of one side, heating elements capable to heat the substrate at least from one side.

The substrate may be tubular having any cross-section, planar or have any desired shape or form suitable for the particular application.

The substrate may be rotated and translated.

The substrate may be heated from inside and/or outside.

The sprayers may be one or more and they may be oscillated, rotated and translated in relations to themselves and to the substrate the deposition takes place on.

The apparatus may be enclosed in vacuum, reduced pressure or any process suitable chamber that may have vacuum and vent valves and gas delivery system.

The deposition process may be under vacuum, reduced pressure., reactive gas, inert gas, plasma, and any combinations thereof.

The process is in atmosphere having desired pressure.

The reactive atmosphere may be plasma, reactive gases or solid, and a process of purification is administered.

The temperature in the chamber may be between temperature equal or greater than room temperature and lower than the melting point of one or more constituents of the deposited body R_{T}≦T≦T_{M}.

The temperature in the chamber may be 400° C.≦T≦800° C.

The temperature in the chamber may be 200° C.≦T≦1000° C.

The temperature in the chamber may be 200° C.≦T≦1200° C. The temperature may be smaller than 200° C. or greater than 1200° C.

The temperature of the substrate may be between temperature equal or greater than room temperature and lower than the melting point of one or more constituents of the deposited body R_{T}≦T≦T_{M}.

The temperature of the substrate may be 400° C.≦T≦800° C.

The temperature of the substrate may be 200° C.≦T≦1000° C.

The temperature of the substrate may be 200° C.≦T≦1200° C. The temperature may be smaller than 200° C. or greater than 1200° C.

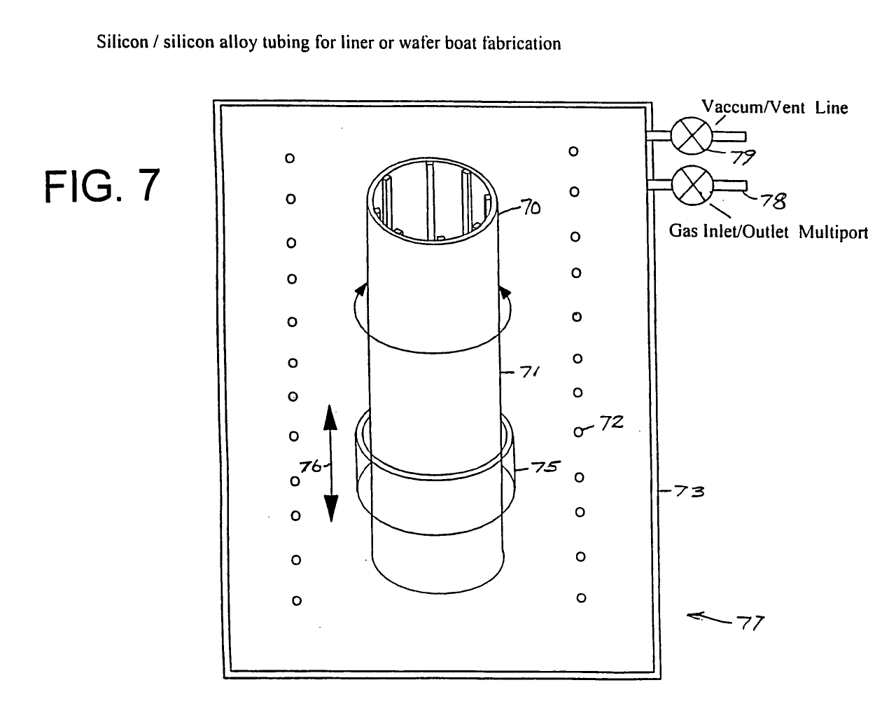

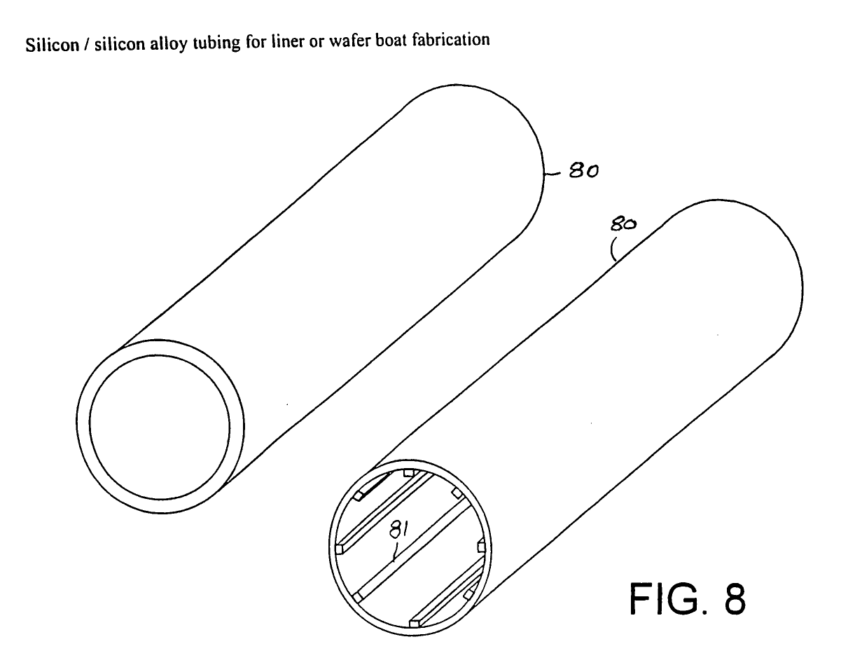

In FIGS. 7 and 8, a silicon preform 71 is placed in a heated 72 chamber 73. The preform is rotated 74 and a heated ring 75 is translation 76 along the preform for sintering and/or melting the material and forming a solid product.

Apparatus 77 for making tubular members 71 has any cross section and length and any other desired shape or form consisting of mold 70 filled with desired material and heater 75 covering part of this mold and a chamber 73 fully or partially surrounding the member 71 and the heating elements 72. The chamber has a gas inlet/outlet, multiport 78 and a vacuum/vent line 79.

The chamber is a vacuum, low pressure or pressure chamber.

In one embodiment, there is no chamber surrounding the member and the heating elements.

The member can be rotated and/or translated.

The member can be heated from the inside and/or outside.

The member can be heated from outside by chamber heaters 72 and a zone heater 75 for directional or non-directional processing.

The chamber has vacuum and/or vent valves 79.

The chamber has a gas inlet/outlet multiport 78.

The chamber has one or more plasma source attached.

The material processed is solid material, powder, powder and organic or inorganic base material, powder and gaseous material. The powder may consist of silicon, silicon compound comprising at least one atom of silicon, silicon and germanium, SiₓGe₁₋ₓ solid solution, silicon and Silicon Carbide Sₓ(SiC)₁₋ₓ, Silicon and silicon dioxide Siₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves at temperature equal or greater than room temperature and lower than the melting point of one or more constituents of the deposited body R_{T}≦T≦T_{M}, consisting of a substrate, plurality of sprayers positioned to spray at least one portion of one side, heating elements capable to heat the substrate at least from one side.

The substrate may be tubular having any cross-section, planar or have any desired shape or form suitable for the particular application.

The processing of the material may be under vacuum, reduced pressure, reactive gas, inert gas, plasma, and any combinations thereof.

The processing of the material is in inert atmosphere having desired pressure.

The reactive atmosphere may be plasma, reactive gases or solid, and a process of purification is administered.

The process temperature may be between temperature equal or greater than room temperature and lower than the melting point of one or more constituents of the deposited body R_{T}≦T≦T_{M}.

The process temperature may be 400° C.≦T≦800° C.

The process temperature may be 200° C.≦T≦1000° C.

The process temperature may be 200° C.≦T≦1200° C. The temperature may be smaller than 200° C. or greater than 1200° C.

The temperature of the substrate may be between temperature equal or greater than room temperature and lower than the melting point of one or more constituents of the deposited body R_{T}≦T≦T_{M}.

The temperature of the substrate may be 400° C.≦T≦800° C.

The temperature of the substrate may be 200° C.≦T≦1000° C.

The temperature of the substrate may be 200° C.≦T≦1200° C. The temperature may be smaller than 200° C. or greater than 1200° C.

The member may be tubular and have any cross section such as round, elliptical, rectangular, polygonal or any other shape.

The member may have uneven thickness pattern over its entire surface.

The member may have different composition and density over the entire body.

The member may have different composition and density over its thickness.

The composition and material properties may be layered over any of the dimensions of the member such as length, thickness, width, radius, etc.

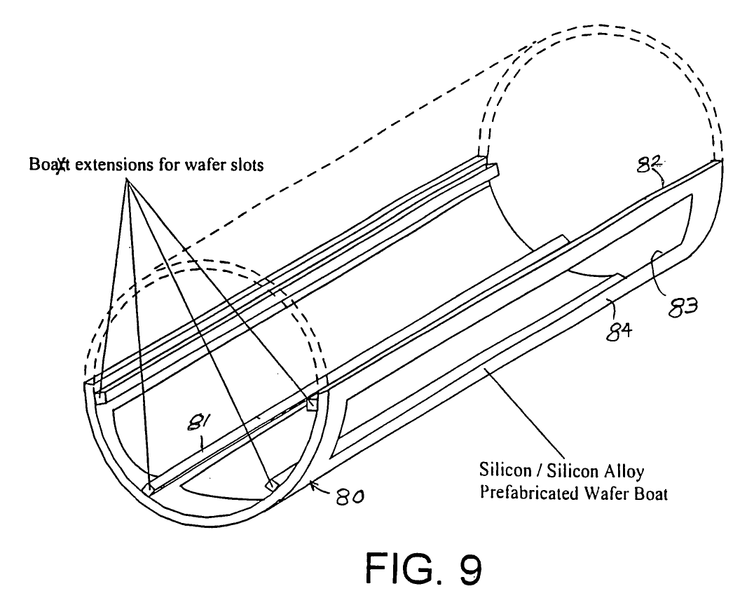

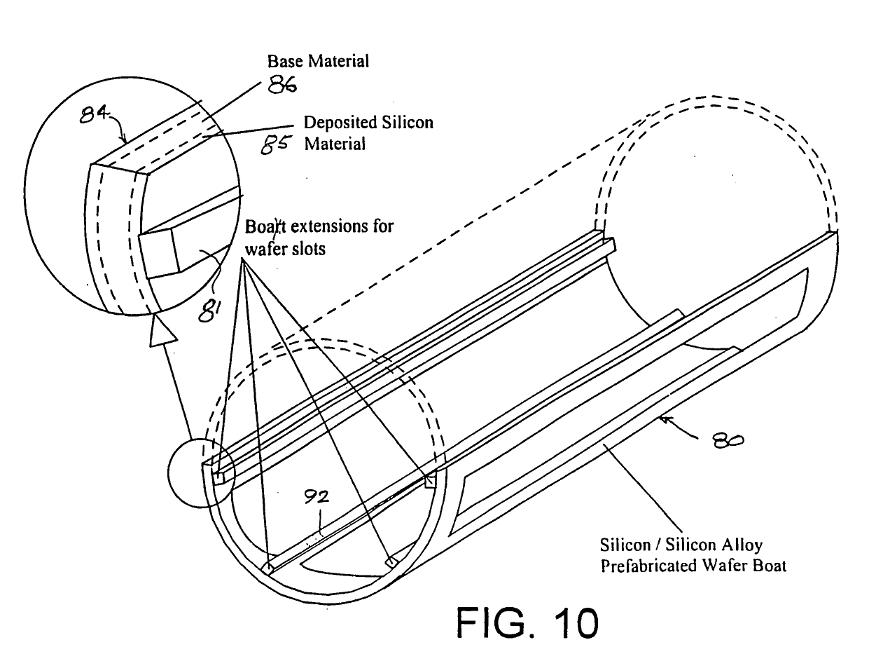

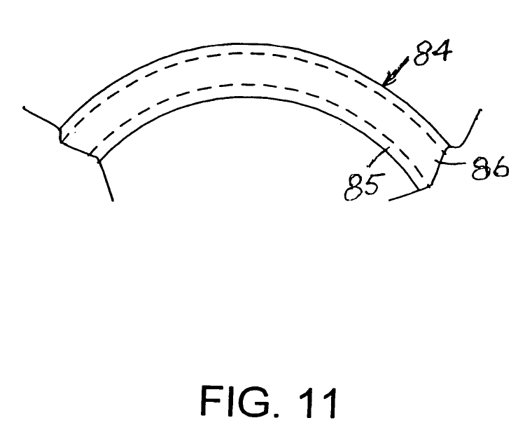

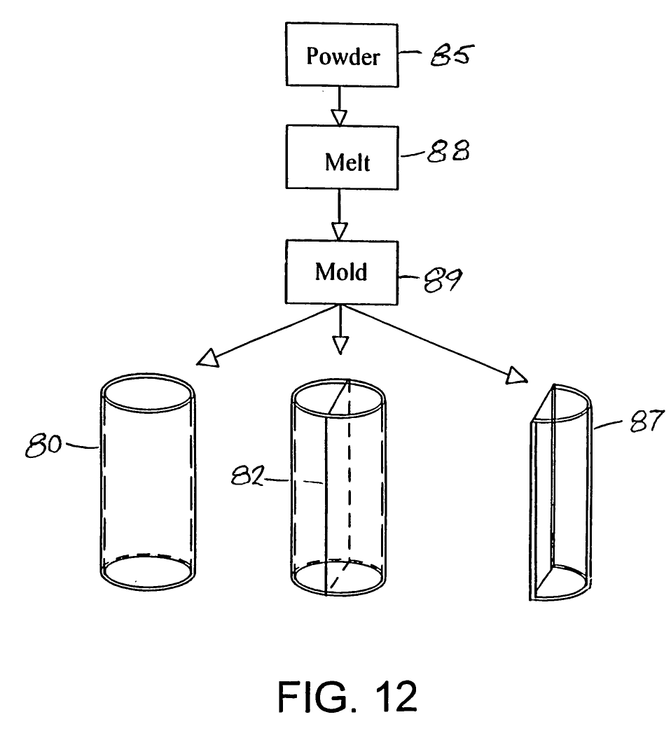

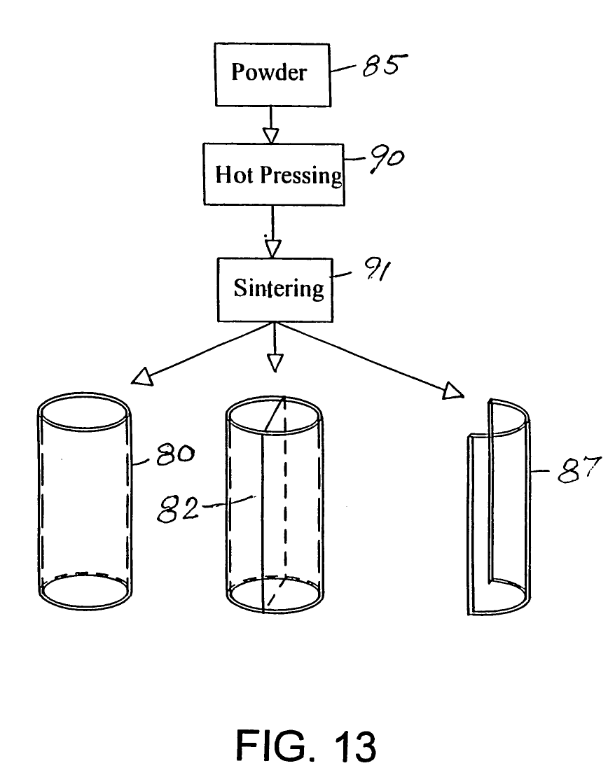

In FIGS. 9, 10, 11, 12 and 13, a horizontal or vertical wafer processing boat preform 80 has a plurality of protrusions 81 for fabrication of slots for wafers and openings for gas flow between the wafers to enable even thickness deposition.

The wafer boat preform 80 may be made from silicon, silicon compound, silicon and germanium, SiₓGe₁₋ₓ, solid solution, silicon and Silicon-Carbide Siₓ(SiC)₁₋ₓ, Silicon and silicon dioxide Siₓ(SiO₂)₁₋ₓ, silicon and any ceramic, silicon and any oxide Sₓ(Oxide)₁₋ₓ, silicon and any metal SiₓM₁₋ₓ, Silicon and any alloy SiₓA₁₋ₓ, any combination between themselves, or made from composite material. In all cases 0x 1.

The wafer boat preform may be made by layering one or more of the following materials: Siₓsilicon compound, SiₓGe₁₋ₓ, SiC, Sₓ(SiC)₁₋ₓ, Siₓ(SiO₂)₁₋ₓ, Sₓ(Oxide)₁₋ₓ, SiₓM₁₋ₓ, composite material, and any combination or order between themselves. In all cases, 0x1.

The wafer boat preform may have closed ends by a base and a top that may be half or full discs having outer diameters equal or greater than the outer diameter of the wafer boat.

The end disk might be solid disk or may have certain portions removed.

The process fabricates wafer boat preforms consisting of silicon, silicon compound, silicon and germanium, SiₓGe₁₋ₓ, solid solution, silicon and Silicon Carbide Siₓ(SiC)₁₋ₓ, Silicon and silicon dioxide Siₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves, or made from composite material (in all cases 0≦x≦1) by heating and melting the boat material within a mold having desired shape and form, or transferring it to the mold, solidifying it, cooling it down at a desired cool-down regime, and machining it to the desired tolerance.

The boat fabrication material is powder.

The boat fabrication material is solid material.

The melting is done in a vacuum chamber.

The melting is done under reduced or high pressure of inert or reactive gas.

The reactive gas is mixture between atomic or charged molecular state gas such as plasma gas and a neutral inert or reactive gas.

The sintering and/or melting is preceded by one or more steps of purging and purification.

Wafer boat preforms consist of silicon, silicon compound, silicon and germanium, SiₓGe₁₋ₓ solid solution, silicon and Silicon Carbide Sₓ(SiC)₁₋ₓ, Silicon and silicon dioxide Siₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves, or made from composite material (in all cases 0≦x≦1) by pressing the boat material within a die having desired shape and form, sintering, cooling it down at a desired cool-down regime, and machining it to the desired tolerance. The boat fabrication material is powder. The boat fabrication material is solid material. The pressing is done in a vacuum chamber. The pressing is done under reduced or high pressure of inert or reactive gas. The reactive gas is mixture between atomic or charged molecular state gas such as plasma gas and a neutral inert or reactive gas.

The melting is preceded by one or more steps of purging and purification.

The process fabricates wafer boat preforms consisting of silicon, silicon compound, silicon and germanium, SiₓGe₁₋ₓ solid solution, silicon and Silicon Carbide Siₓ(SiC)₁₋ₓ, Silicon and silicon dioxide Siₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves, or made from composite material (in all cases 0≦x≦1) by extruding the boat material within a die having desired shape and form, sintering, cooling it down at a desired cool-down regime, and machining it to the desired tolerance. The boat fabrication material is powder. The boat fabrication material is powder mixed with organic or inorganic material, or the boat fabrication material is solid material. The pressing is done in a vacuum chamber. The pressing is done under reduced or high pressure of inert or reactive gas. The reactive gas is mixture between atomic or charged molecular state gas such as plasma gas and a neutral inert or reactive gas. The melting is preceded by one or more steps of purging and purification.

The invention provides processes for fabrication of member having shape of tube, plate, rod or any other shape consisting of silicon, silicon compound including but not limited to SiN, Si₃N₄, SiON, and/or the like, silicon and germanium, SiₓGe₁₋ₓ solid solution, silicon and Silicon Carbide Siₓ(SiC)₁₋ₓ, Silicon and silicon dioxide Siₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves, or made from composite material (in all cases 0≦x≦1) by heating and melting the member material within a mold having desired shape and form, or transferring it to the mold, solidifying it, cooling it down at a desired cool-down regime, and machining it to the desired tolerance. The member fabrication material is powder, or the member fabrication material is solid material.

The process is done in a reduced pressure chamber.

The melting is done under reduced or high pressure of inert or reactive gas. The reactive gas is mixture between atomic or charged molecular state gas such as plasma gas and a neutral inert or reactive gas. The melting is preceded by one or more steps of purging and purification.

The new process provides for fabrication of members having shape of tube, plate, rod or any other shape consisting of silicon, silicon and germanium, SiₓGe₁₋ₓ solid solution, silicon and Silicon Carbide Siₓ(SiC)₁₋ₓ, Silicon and silicon dioxide Sₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves, or made from composite material (in all cases 0≦x≦1) by pressing the member material within a die having desired shape and form, sintering, cooling it down at a desired cool-down regime, and machining it to the desired tolerance. The member fabrication material is powder, or the member fabrication material is solid material. The pressing is done in a vacuum chamber. The pressing is done under reduced or high pressure of inert or reactive gas.

The reactive gas is mixture between atomic or charged molecular state gas such as plasma gas and a neutral inert or reactive gas. The melting is preceded by one or more steps of purging and purification.

The new process provides for fabrication of member having shape of tube, plate, rod or any other shape consisting of silicon, silicon compound including but not limited to SiN, Si₃N₄, SiON, and/or the like, silicon and germanium, SiₓGe₁₋ₓ solid solution, silicon and Silicon Carbide Sₓ(SiC)₁₋ₓ, Silicon and silicon dioxide Sₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ any combination between themselves, or made from composite material (in all cases 0≦x≦1) by extruding the member material within a die having desired shape and form, sintering, cooling it down at a desired cool-down regime, and machining it to the desired tolerance.

The member fabrication material is powder.

The member fabrication material is powder mixed with organic or inorganic material.

The member fabrication material is solid material.

The pressing is done in a vacuum chamber.

The pressing is done under reduced or high pressure of inert and/or reactive gas.

The reactive gas is mixture between atomic or charged molecular state gas such as plasma gas and a neutral inert or reactive gas.

The sintering may be preceded by one or more steps of purging and purification.

The melting is preceded by one or more steps of purging and purification.

The material may be made only by sintering and without melting.

The process cuts the preform or solidified boat 80 in two along medial lines 82. Openings 83 are formed in the cylindrical walls 84. Deposited material 85 is coated and fused on top of base material 86. Two boats 87 result. The powder 85 is melted 88 or molded 89, or hot pressed 90 and sintered 91. Finally slots 92 are formed in the inward ribs or extensions 81. Ends 93 of boats 87 may have complementary steps to connect boats end-to-end in an axial stack or row.

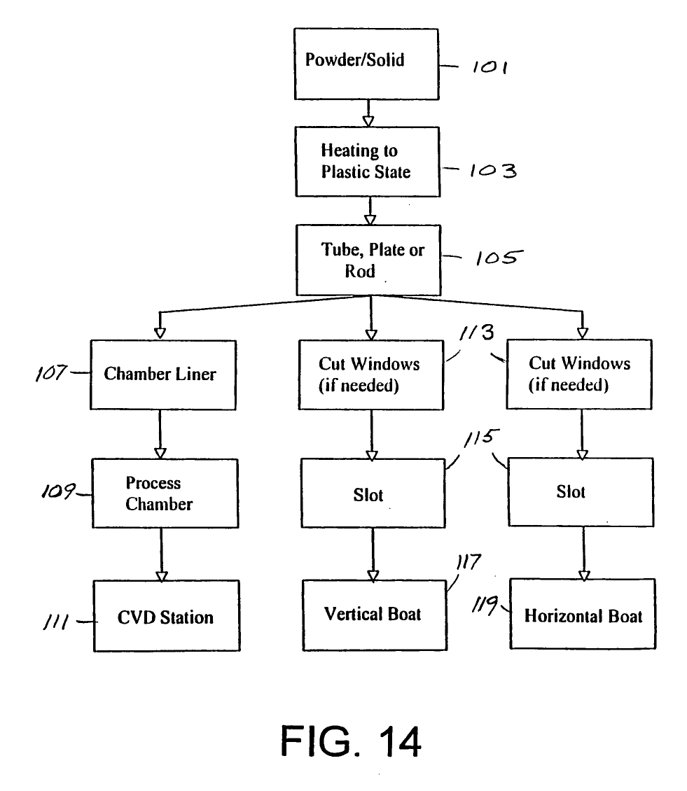

FIG. 14 shows steps of beginning with a powder or solid 101, heating 103 to a plastic slate and forming 105 a tube, plate or rod. A chamber liner 107 is formed and applied to a process chamber 109, forming a chemical vapor deposition (CVD) station 111. Formed tubes 105 are halved lengthwise. Windows are cut 113. Inward ribs or extensions or the inner walls are slotted 115, forming a vertical boat 117. In parallel steps, windows are cut 113. The boat is plotted 115 and a horizontal boat 119 is formed.

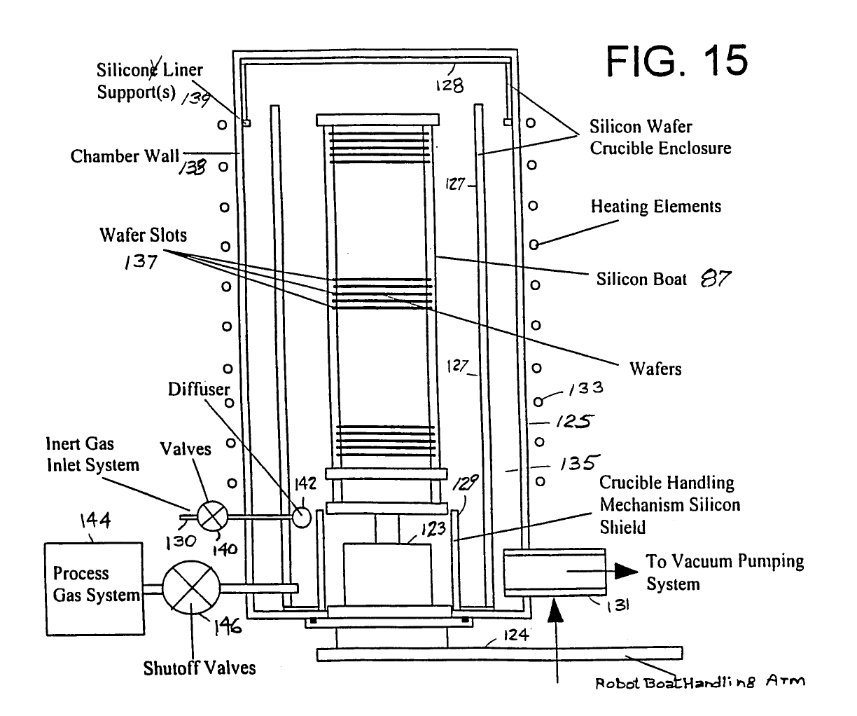

In FIG. 15, wafer processing apparatus 120 consists of a process chamber 121, wafer handling tools, wafer boat handling tools 123, 124, consisting of one or more processing chambers 127, 128, shields 125 and enclosures 129 employing one or more members consisting of silicon, silicon and germanium, SiₓGe₁₋ₓ solid solution, silicon and Silicon Carbide Siₓ(SiC)₁₋ₓ, Silicon and silicon dioxide Siₓ(SiO₂₎₁₋ₓ, silicon and any ceramic, silicon and any oxide Siₓ(Oxide)₁₋ₓ, silicon and any metal SiₓM₁₋ₓ, Silicon and any alloy SiₓA₁₋, any combination between themselves, or made from composite material (in all cases 0≦x≦1). Each chamber may be equipped with separate or common gas delivery and venting system 130, vacuum system 131, internal or external heating elements 133, cooled or not cooled vacuum shell 135, partially or fully lined with silicon, silicon and germanium, SiₓGe₁₋ₓ solid solution, silicon and Silicon Carbide Sₓ(SiC)₁₋ₓ, Silicon and silicon dioxide Sₓ(SiO₂)₁₋ₓ, silicon and any ceramic, silicon and any oxide Sₓ(Oxide)₁₋ₓ, silicon and any metal SiₓM₁₋ₓ, Silicon and any alloy SiₓA₁₋ₓ, any combination between themselves, or made from composite material (in all cases 0≦x≦1).

At least one of the processing chambers may be a CVD chamber employing one or more members consisting of silicon, silicon and germanium, SiₓGe₁₋ₓ solid solution, silicon and Silicon Carbide Siₓ(SiC)₁₋ₓ, Silicon and silicon dioxide Siₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves, or made from composite material (in all cases 0≦x≦1). The CVD chamber may be equipped with separate or common gas delivery and venting system, vacuum system, internal or external heating elements, cooled or not cooled vacuum shell partially or fully lined with silicon, silicon and germanium, SiₓGe₁₋ₓ solid solution, silicon and Silicon Carbide Sₓ(SiC)₁₋ₓ, Silicon and silicon dioxide Siₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves, or made from composite material (in all cases 0≦x≦1).

At least one of the processing chambers may be an epitaxial chamber employing one or more members consisting of silicon, silicon and germanium, SiₓGe₁₋ₓ solid solution, silicon and Silicon Carbide Sₓ(SiC)₁₋ₓ, Silicon and silicon dioxide Siₓ(SiO₂)₁₋ₓ, silicon and any ceramic, silicon and any oxide Sₓ(Oxide)₁₋ₓ, silicon and any metal SiₓM₁₋ₓ, Silicon and any alloy SiₓA₁₋ₓ, any combination between themselves, or made from composite material (in all cases 0≦x≦1). The epitaxial chamber may be equipped with separate or common gas delivery and venting system, vacuum system, internal or external heating elements, cooled or not cooled vacuum shell partially or fully lined with silicon, silicon and germanium, SiₓGe₁₋ₓ, solid solution, silicon and Silicon Carbide Sₓ(SiC)₁₋ₓ Silicon and silicon dioxide Siₓ(SiO₂₎₁₋ₓ, silicon and any ceramic, silicon and any oxide Sₓ(Oxide)₁₋ₓ, silicon and any metal SiₓM₁₋ₓ, Silicon and any alloy SiₓA₁₋ₓ, any combination between themselves, or made from composite material (in all cases 0≦x≦1).

At least one of the processing chambers may be a thin film deposition chamber employing one or more members consisting of silicon, silicon and germanium, SiₓGe₁₋ₓ solid solution, silicon and Silicon Carbide Siₓ(SiC)₁₋ₓ, Silicon and silicon dioxide Siₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves, or made from composite material (in all cases 0≦x≦1). The thin film deposition chamber may be equipped with separate or common gas delivery and venting system, vacuum system, internal or external heating elements, cooled or not cooled vacuum shell partially or fully lined with silicon, silicon and germanium, SiₓGe₁₋ₓ solid solution, silicon and Silicon Carbide Siₓ(SiC)₁₋ₓ, Silicon and silicon dioxide Siₓ(SiO₂)₁₋ₓ, silicon and any ceramic, silicon and any oxide Sₓ(Oxide)₁₋ₓ, silicon and any metal SiₓM₁₋ₓ, Silicon and any alloy SiₓA₁₋ₓ, any combination between themselves, or made from composite material (in all cases 0≦x≦1).

At least one of the processing chambers may thin film removal chamber employing one or more members consisting of silicon, silicon and germanium, SiₓGe₁₋ₓ solid solution, silicon and Silicon Carbide Sₓ(SiC)₁₋ₓ, Silicon and silicon dioxide Siₓ(SiO₂)₁₋ₓ, silicon and any ceramic, silicon and any oxide Sₓ(Oxide)₁₋ₓ, silicon and any metal SiₓM₁₋ₓ, Silicon and any alloy SiₓA₁₋ₓ, any combination between themselves, or made from composite material (in all cases 0≦x≦1). The thin film removal chamber may be equipped with separate or common gas delivery and venting system, vacuum system, internal or external heating elements, cooled or not cooled vacuum shell partially or fully lined with silicon, silicon and germanium, SiₓGe₁₋ₓ solid solution, silicon and Silicon Carbide Siₓ(SiC)₁₋ₓ, Silicon and silicon dioxide Siₓ(SiO₂)₁₋ₓ, silicon and any ceramic, silicon and any oxide Sₓ(Oxide)₁₋ₓ, silicon and any metal SiₓM₁₋ₓ, Silicon and any alloy SiₓA₁₋ₓ, any combination between themselves, or made from composite material (in all cases 0≦x≦1).

One of the chambers may be a main chamber connected with other chambers directly or via one or more gate valves.

One or more chambers may be vacuum, low pressure or desired pressure chamber.

One or more chambers may have at least one internal or external heater.

One or more chambers may have at least one partial or complete heat shield.

Wafer processing apparatus employing at least one CVD chamber employing one or more members consisting of silicon, silicon and germanium, SiₓGe₁₋ₓ, solid solution, silicon and Silicon Carbide Siₓ(SiC)₁₋ₓ, Silicon and silicon dioxide Sₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves, or made from composite material (in all cases 0≦x≦1). The CVD chamber may be equipped with separate or common gas delivery and venting system, vacuum system, internal or external heating elements, cooled or not cooled vacuum shell partially or fully lined with silicon, silicon and germanium, SiₓGe₁₋ₓ solid solution, silicon and Silicon Carbide Siₓ(SiC)₁₋ₓ, Silicon and silicon dioxide Siₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves, or made from composite material (in all cases 0≦x≦1).

At least one CVD chamber may be connected with other chambers or with a main wafer distribution chamber directly or via one or more gate valves.

At least one CVD chamber may be vacuum, low pressure or desired pressure chamber.

At least one CVD chamber may have at least one internal or external heater.

At least one CVD chamber may have at least one partial or complete heat shield.

Wafer processing apparatus employing at least one epitaxial chamber employing one or more members consisting of silicon, silicon and germanium, SiₓGe₁₋ₓ solid solution, silicon and Silicon Carbide Sₓ(SiC)₁₋ₓ, Silicon and silicon dioxide Sₓ(SiO₂)₁₋ₓ, silicon and any ceramic, silicon and any oxide Sₓ(Oxide)₁₋ₓ, silicon and any metal SiₓM₁₋ₓ, Silicon and any alloy SiₓA₁₋ₓ, any combination between themselves, or made from composite material (in all cases 0≦x≦1). The epitaxial chamber may be equipped with separate or common gas delivery and venting system, vacuum system, internal or external heating elements, cooled or not cooled vacuum shell partially or fully lined with silicon, silicon and germanium, SiₓGe₁₋ₓ, solid solution, silicon and Silicon Carbide Siₓ(SiC)₁₋ₓ, Silicon and silicon dioxide Siₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ any combination between themselves, or made from composite material (in all cases 0≦x≦1.

At least one epitaxial chamber may be connected with other chambers or with a main wafer distribution chamber directly or via one or more gate valves.

At least one epitaxial chamber may be vacuum, low pressure or desired pressure chamber.

At least one epitaxial chamber may have at least one internal or external heater.

At least one epitaxial chamber may have at least one partial or complete heat shield.

Wafer processing apparatus employing at least one thin film deposition chamber employing one or more members consisting of silicon, silicon and germanium, SiₓGe₁₋ₓ solid solution, silicon and Silicon Carbide Sₓ(SiC)₁₋ₓ, Silicon and silicon dioxide Sₓ(SiO₂)₁₋ₓ, silicon and any ceramic, silicon and any oxide Sₓ(Oxide)₁₋ₓ, silicon and any metal SiₓM₁₋ₓ, Silicon and any alloy SiₓA₁₋ₓ, any combination between themselves, or made from composite material (in all cases 0≦x≦1). The thin film deposition chamber may be equipped with separate or common gas delivery and venting system, vacuum system, internal or external heating elements, cooled or not cooled vacuum shell partially or fully lined with silicon, silicon and germanium, SiₓGe₁₋ₓ, solid solution, silicon and Silicon Carbide Sₓ(SiC)₁₋ₓ, Silicon and silicon dioxide Sₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves, or made from composite material (in all cases 0≦x≦1).

At least one thin film deposition chamber may be connected with other chambers or with a main wafer distribution chamber directly or via one or more gate valves.

At least one thin film deposition chamber may be vacuum, low pressure or desired pressure chamber.

At least one thin film deposition chamber may have at least one internal or external heater.

At least one thin film deposition chamber may have at least one partial or complete heat shield.

Wafer processing apparatus employing at least one thin film removal chamber employing one or more members consisting of silicon, silicon and germanium, SiₓGe₁₋ₓ solid solution, silicon and Silicon Carbide Siₓ(SiC)₁₋ₓ, Silicon and silicon dioxide Sₓ(SiO₂)₁₋ₓ, silicon and any ceramic, silicon and any oxide Siₓ(Oxide)₋ₓ, silicon and any metal SiₓM₁₋ₓ, Silicon and any alloy SiₓA₁₋ₓ, any combination between themselves, or made from composite material (in all cases 0≦x≦1). The thin film removal chamber may be equipped with separate or common gas delivery and venting system, vacuum system, internal or external heating elements, cooled or not cooled vacuum shell partially or fully lined with silicon, silicon and germanium, SiₓGe₁₋ₓ solid solution, silicon and Silicon Carbide Siₓ(SiC)₁₋ₓ, Silicon and silicon dioxide Siₓ(SiO₂)₁₋ₓ, silicon and any ceramic, silicon and any oxide Sₓ(Oxide)₁₋ₓ, silicon and any metal SiₓM₁₋ₓ, Silicon and any alloy SiₓA₁₋ₓ, any combination between themselves, or made from composite material (in all cases 0≦x≦1).

At least one thin film removal chamber may be connected with other chambers or with a main wafer distribution chamber directly or via one or more gate valves.

At least one thin film removal chamber may be vacuum, low pressure or desired pressure chamber.

At least one thin film removal-chamber may have at least one internal or external heater.

At least one thin film removal chamber may have at least one partial or complete heat shield.

A chemical vapor deposition (CVD) system consisting of a vacuum vessel with cooled or not cooled chamber with single or double wall, a robot handling arm having appropriate elements for wafer or wafer boat delivery/removal that forms a vacuum tight seal when the chamber is loaded, a wafer tray/boat containing one or more wafers resting on the wafer boat delivery/removal arm, a shield surrounding the wafer tray/boat and the inside portion of the wafer handling arm, process gas delivery system with all appropriate valves attached to the chamber and having an delivery tube extending into wafer area, inert gas delivery system with all appropriate valves attached to the chamber and having an delivery tube with or without diffuser extending into wafer area, vacuum pumping system connected to the chamber, inside or outside heater directing heat into the process area employing one or more members consisting of silicon, silicon and germanium, SiₓGe₁₋ₓ solid solution, silicon and Silicon Carbide Siₓ(SiC)₁₋ₓ, Silicon and silicon dioxide Siₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves, or made from composite material (in all cases 0≦x≦1.

The CVD system may be vertical, horizontal or have any suitable position from −90 to +90.

The wafer boat may be solid connected members made from silicon, silicon and germanium, SiₓGe₁₋ₓ solid solution, silicon and Silicon Carbide Siₓ(SiC)₁₋ₓ, Silicon and silicon dioxide Siₓ(SiO₂)₁₋ₓ, silicon and any ceramic, silicon and any oxide Sₓ(Oxide)₁₋ₓ, silicon and any metal SiₓM₁₋ₓ, Silicon and any alloy SiₓA₁₋ₓ, any combination between themselves, or made from composite material (in all cases 0≦x≦1).

The wafer boat may be modular elements made from silicon, silicon and germanium, SiₓGe₁₋ₓ solid solution, silicon and Silicon Carbide Siₓ(SiC)₁₋ₓ, Silicon and silicon dioxide Siₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves, or made from composite material (in all cases 0≦x≦1).

The wafer boat may contain one or more slots for wafers support spaced at appropriate distance.

The wafers in the boat may be positioned so there is no other material between the wafers other than vacuum or any gas present in the processing part of the chamber.

The wafer boat may have slots for the wafer support and susceptors between the wafers for improved temperature distribution over the wafer surface that results in more uniform deposited layer thickness and composition.

The susceptor in boat may part of the wafer boat.

The susceptor in boat may be inserted after the boat has been made or prior to or together with the wafer loading.

The boat may be modular.

Each module of the boat may contain support for one or more wafers.

Each module may contain support for one or more wafers separated by inserted or built in susceptors.

The susceptor may be full body or may have certain cuts to allow wafer only insertion/removal handling.

The boat may be made from modular parts connected via chemical or mechanical bonding.

The boat may have round, elliptical, polygonal or any other applicable cross section.

The boat may have one or more elements at each end for mechanical strength during handling.

The end parts of the boat may be modules.

All parts of the boat may be made from same or different materials.

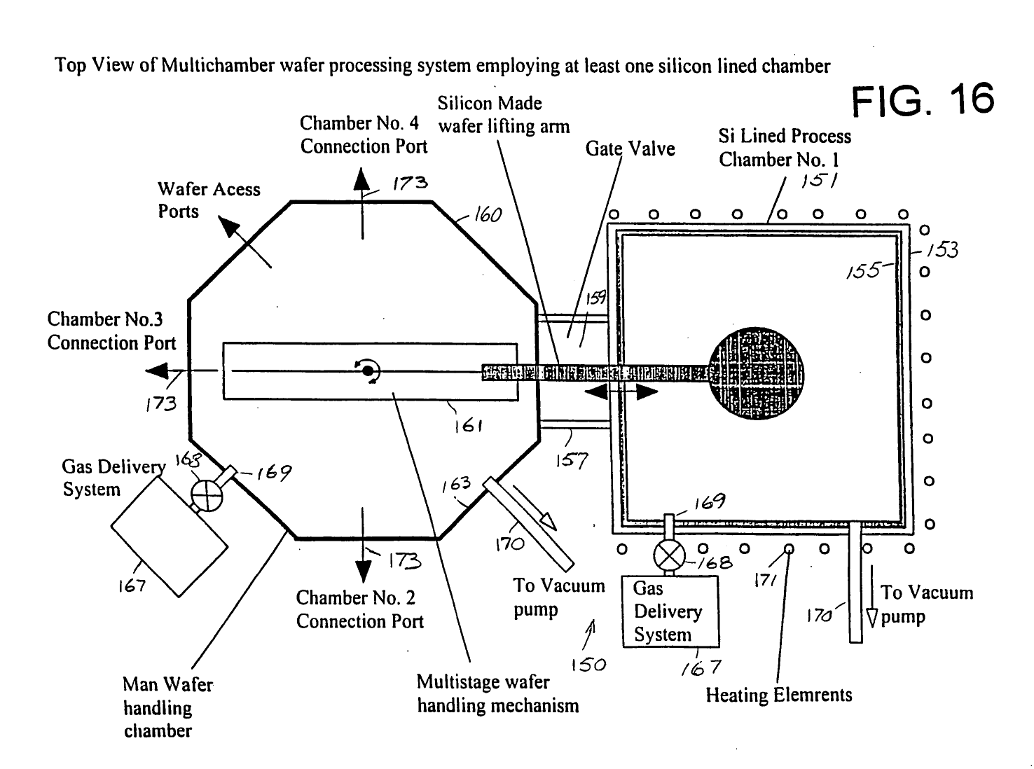

In FIG. 16, a single wafer processing system 150 for CVD, epitaxial deposition, thin film deposition/removal or any other wafer processing the chip requires system consists of a vacuum vessel 151 with cooled or not cooled chamber wall 153 with single or double wall 155, connected directly 157 or through at least one gate valve 159 to a chamber 160 with multistage wafer handling mechanism 161 for wafer delivery/removal, a shield 163 surrounding the wafer processing area, process and inert gas delivery system 165 with all appropriate valves 167 attached to the chamber 160 and having an delivery tube 169 extending into wafer area, vacuum pumping system 170 connected to the chamber 160, inside and/or outside heater directing heat into the process area employing one or more members consisting of silicon, silicon and germanium, SiₓGe₁₋ₓ solid solution, silicon and Silicon Carbide Siₓ(SiC)₁₋ₓ, Silicon and silicon dioxide Sₓ(SiO₂)₁₋ₓ, silicon and any ceramic, silicon and any oxide Sₓ(Oxide)₁₋ₓ, silicon and any metal SiₓM₁₋ₓ, Silicon and any alloy SiₓA₁₋ₓ, any combination between themselves, or made from composite material (in all cases≦x≦1).

Similar vacuum pumping systems 170 and gas delivery systems 167 may be used with both chambers. Heating elements 171 may be located around or in the chambers 151 and 160. Chamber connection ports 173 are provided to connect chamber 160 to additional chambers for transferring or removing the wafers.

The process chamber may be a CVD chamber.

The process chamber may be an epitaxial deposition chamber.

The process chamber may be a thin film deposition/removal chamber.

The process chamber may be any wafer process chamber.

The chamber may have any cross section and height and the system may be vertical, horizontal or have any suitable position from −90 to +90.

The members are made from silicon, silicon and germanium, SiₓGe₁₋ₓ solid solution, silicon and Silicon Carbide Sₓ(SiC)₁₋ₓ, Silicon and silicon dioxide Sₓ(SiO₂)₁₋ₓ, silicon and any ceramic, silicon and any oxide Sₓ(Oxide)₁₋ₓ, silicon and any metal SiₓM₁₋ₓ, Silicon and any alloy SiₓA₁₋ₓ, any combination between themselves, or made from composite material (in all cases 0≦x≦1) and may be solidly connected by means of chemical or mechanical bonding.

The members are made from silicon, silicon and germanium, SiₓGe₁₋ₓ solid solution, silicon and Silicon Carbide Sₓ(SiC)₁₋ₓ, Silicon and silicon dioxide Siₓ(SiO₂)₁₋ₓ, silicon and any ceramic, silicon and any oxide Sₓ(Oxide)₁₋ₓ, silicon and any metal SiₓM₁₋ₓ, Silicon and any alloy SiₓA₁₋ₓ, any combination between themselves, or made from composite material (in all cases 0≦x≦1) and may be modular.

The members are made from silicon, silicon and germanium, SiₓGe₁₋ₓ solid solution, silicon and Silicon Carbide Sₓ(SiC)₁₋ₓ, Silicon and silicon dioxide Siₓ(SiO₂)₁₋ₓ, silicon and any ceramic, silicon and any oxide Sₓ(Oxide)₁₋ₓ, silicon and any metal SiₓM₁₋ₓ, Silicon and any alloy SiₓA₁₋ₓ, any combination between themselves, or made from composite material (in all cases 0≦x≦1) and may contain one or more slots for wafers' support to optimize the process.

The wafer processing chamber may have a susceptor next to the wafer for improved temperature distribution over the wafer surface that results in more uniform deposited layer thickness and composition.

The susceptor in the process chamber may be part of the chamber.

The wafer delivery arm may be made in full or partially from silicon, silicon and germanium, SiₓGe₁₋ₓ solid solution, silicon and Silicon Carbide Sₓ(SiC)₁₋ₓ, Silicon and silicon dioxide Siₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves, or made from composite material (in all cases 0≦x≦1)

The susceptor may be full body or may have certain cuts to allow wafer only insertion/removal handling.

The chamber parts may be made in full or partially from silicon, silicon and germanium, SiₓGe₁₋ₓ solid solution, silicon and Silicon Carbide Sₓ(SiC)₁₋ₓ, Silicon and silicon dioxide Siₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves, or made from composite material (in all cases 0≦x≦1) and they may be made from modular parts connected via chemical or mechanical bonding or by assembling them without bonding.

The chamber may have round, elliptical, polygonal or any other applicable cross section.

The end parts of the wafer processing chamber may be modules. All parts of the boat may be made from the same or different materials.

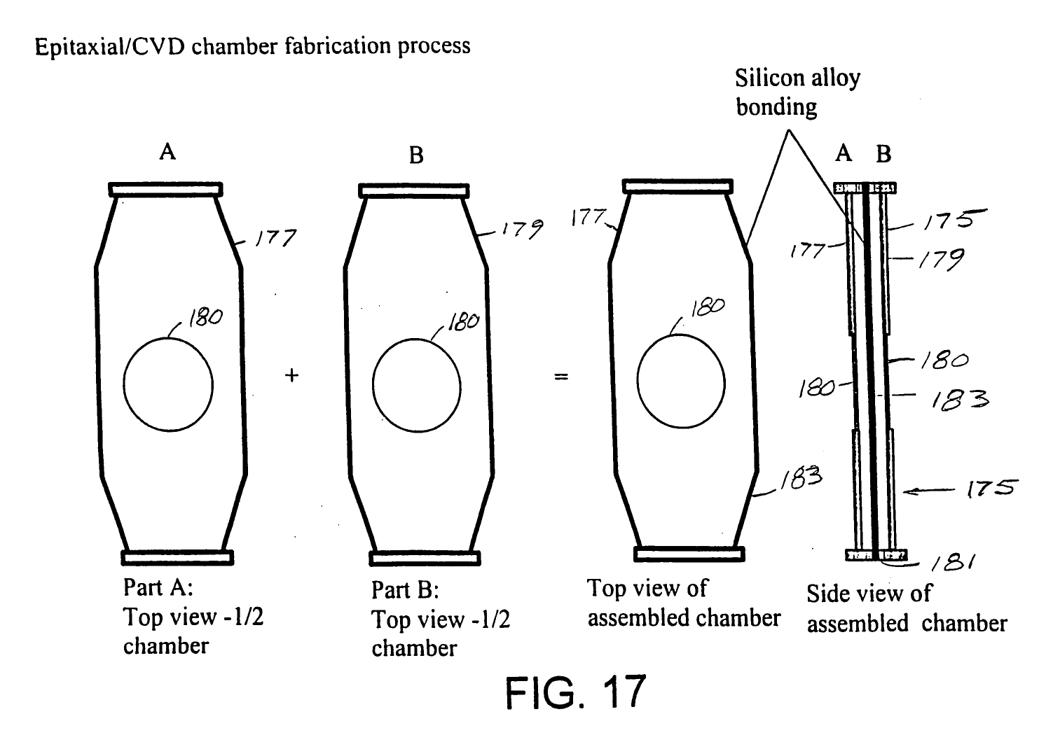

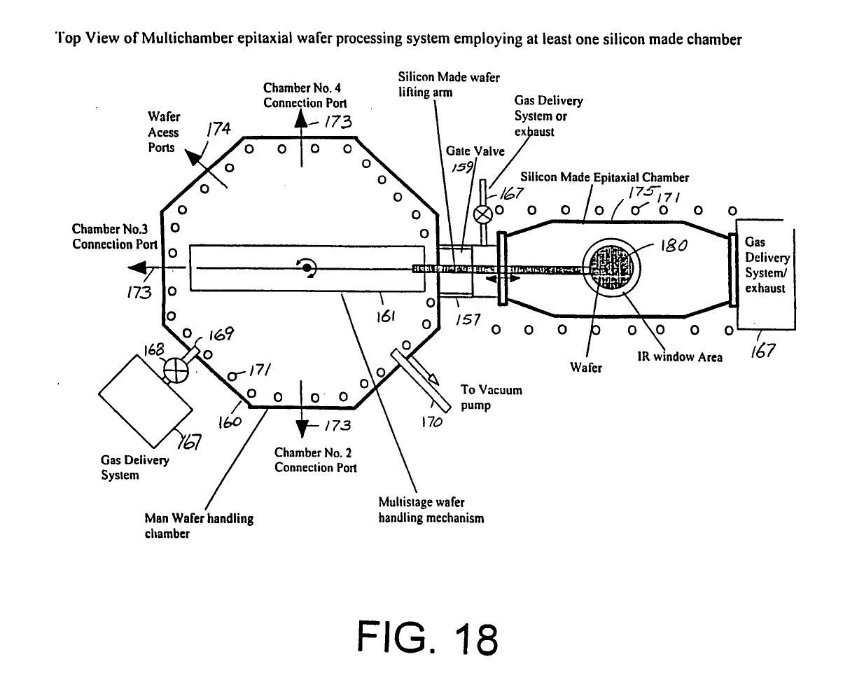

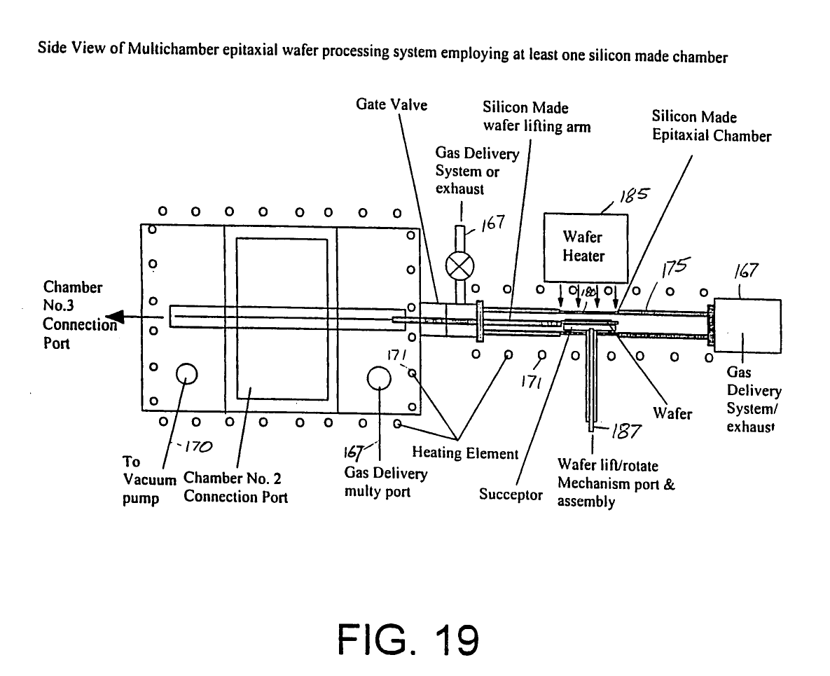

FIG. 17-19 show epitaxial/CVD chambers 175 made in full or partially from silicon, silicon and germanium, SiₓGe₁₋ₓ solid solution, silicon and Silicon Carbide Sₓ(SiC)₁₋ₓ, Silicon and silicon dioxide Siₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves, or made from composite material (in all cases 0≦x≦1) having a body 177, 179, an optical window 180 for wafer radiation and at least one opening 181 for wafer and gas delivery/removal. The bodies are bonded together along side edges 183 forming the chamber 175. A wafer heater 185 accesses wafers in chamber 175 through one window 180. A wafer lifting and rotating mechanism port and assembly 187 supports wafers through the opposite window.

Epitaxial chambers have suitable wall thickness and at least one infrared window at each side, hollow interior and at least one gate opening for connection to a wafer supply and process gas supply chamber and a gas exhaust is made from silicon, silicon and germanium, SiₓGe₁₋ₓ solid solution, silicon and Silicon Carbide Sₓ(SiC)₁₋ₓ, Silicon and silicon dioxide Sₓ(SiO₂)₁₋ₓ, silicon and any ceramic, silicon and any oxide Sₓ(Oxide)₁₋ₓ, silicon and any metal SiₓM₁₋ₓ, Silicon and any alloy SiₓA₁₋ₓ, any combination between themselves, or made from composite material (in all cases 0≦x≦1).

The epitaxial chamber body may comprise of a single body made by pressing of material, machining it from inside and out in its green state, purifying the said body at a certain temperature by immersing it in a chemically reactive gas, plasma or liquid for certain period of time, sintering the said body at appropriate temperature determined by its composition, final machining of the said body, if needed, to meet the specifications of the epitaxial deposition process. The finished body may be subjected to thin film deposition such as chemical vapor deposition, plasma enhanced deposition, or other suitable deposition method for better finish on the inside and outside.

The epitaxial chamber body may comprise of a single body made by casting of the material, machining it from inside and out in its green state, purifying the said body at a certain temperature by immersing it in a chemically reactive gas, plasma or liquid for certain period of time, sintering the said body at appropriate temperature determined by its composition, final machining of the said body, if needed, to meet the specifications of the epitaxial deposition process. The finished body may be subjected to thin film deposition such as chemical vapor deposition, plasma enhanced deposition, or other suitable deposition method for better finish on the inside and outside.

The epitaxial chamber may comprise of upper and lower part made by casting to shape the material, machining the parts, purifying the said body at a certain temperature by immersing it in a chemically reactive gas, plasma or liquid for certain period of time, sintering the said body at appropriate temperature determined by its composition, joining the parts by chemical and/or mechanical means, final machining of the said body, if needed, to meet the specifications of the epitaxial deposition process. The finished body may be subjected to thin film deposition such as chemical vapor deposition, plasma enhanced deposition, or other suitable deposition method for better finish on the inside and outside.

The epitaxial chamber may comprise of upper and lower part made by cold or hot pressing to shape to shape the material, machining the parts, purifying the said body at a certain temperature by immersing it in a chemically reactive gas, plasma or liquid for certain period of time, sintering the said body at appropriate temperature determined by its composition, joining the parts by chemical and/or mechanical means, final machining of the said body, if needed, to meet the specifications of the epitaxial deposition process. The finished body may be subjected to thin film deposition such as chemical vapor deposition, plasma enhanced deposition, or other suitable deposition method for better finish on the inside and outside.

The epitaxial chamber may comprise of upper and lower part made by cold or hot pressing of a block of the material, machining the chamber, purifying the said body at a certain temperature by immersing it in a chemically reactive gas, plasma or liquid for certain period of time, sintering the said body at appropriate temperature determined by its composition, joining the parts by chemical and/or mechanical means, final machining of the said body, if needed, to meet the specifications of the epitaxial deposition process. The finished body may be subjected to thin film deposition such as chemical vapor deposition, plasma enhanced deposition, or other suitable deposition method for better finish on the inside and outside.

The epitaxial chamber may comprise of upper and lower part made by cold or hot extrusion of a block or a desired shape of the material, machining the chamber, purifying the said body at a certain temperature by immersing it in a chemically reactive gas, plasma or liquid for certain period of time, sintering the said body at appropriate temperature determined by its composition, joining the parts by chemical and/or mechanical means, final machining of the said body, if needed, to meet the specifications of the epitaxial deposition process. The finished body may be subjected to thin film deposition such as chemical vapor deposition, plasma enhanced deposition, or other suitable deposition method for better finish on the inside and outside.

The epitaxial chamber may comprise of upper and lower part made by plasma spraying of the material, and forming a chamber to a desired shape, machining the chamber, purifying the said body at a certain temperature by immersing it in a chemically reactive gas, plasma or liquid for certain period of time, sintering the said body at appropriate temperature determined by its composition, joining the parts by chemical and/or mechanical means, final machining of the said body, if needed, to meet the specifications of the epitaxial deposition process. The finished body may be subjected to thin film deposition such as chemical vapor deposition, plasma enhanced deposition, or other suitable deposition method for better finish on the inside and outside.

The epitaxial chamber may comprise of upper and lower part made by spraying of organic or inorganic based slurry of the material and forming a chamber to a desired shape, machining the chamber, purifying the said body at a certain temperature by immersing it in a chemically reactive gas, plasma or liquid for certain period of time, sintering the said body at appropriate temperature determined by its composition, joining the parts by chemical and/or mechanical means, final machining of the said body, if needed, to meet the specifications of the epitaxial deposition process. The finished body may be subjected to thin film deposition such as chemical vapor deposition, plasma enhanced deposition, or other suitable deposition method for better finish on the inside and outside.

The chamber comprises two separate halves joined at one plane followed by final machining.

The chamber comprises a single body machined from a solid block material.

The chamber comprises a single body made by method of plasma spraying followed by final machining.

The chamber comprises a single body made by method of slurry spraying

The chamber comprises a single body machined by method of casting, forging or extrusion followed by final machining.

The chamber may be a vacuum, reduced pressure or desired pressure chamber.

The chamber may have a liner for a vacuum, reduced pressure or desired pressure chamber for wafer processing applications.

The chamber may be modular pieces stacked on top of each other or bonded by mechanical or chemical means.

The optical window may be from same or suitable material stacked on the chamber or bonded by mechanical or chemical means.

The chamber may have one or more optical windows depending on the process requirements.

Gas delivery system 167 for delivering process and inert gases into the chamber may attached to the chamber or to the chamber wall.

The gas delivery members exposed to the process atmosphere may be made from the chamber material or chamber lining material.

The wafer delivering/removing arm to/from the chamber may be made from the chamber material or chamber lining material.

The susceptor and any other member that either holds the wafer, surround the wafer from the sides, the top or the bottom, as required by the process may be made from the chamber material or chamber lining material.

Reduced pressure chamber surrounds epitaxial/CVD chamber made in full or partially from silicon, silicon and germanium, SiₓGe₁₋ₓ solid solution, silicon and Silicon Carbide Siₓ(SiC)₁₋ₓ, Silicon and silicon dioxide Siₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves, or made from composite material (in all cases 0≦x≦1) having a body, an optical window for wafer radiation and at least one opening for wafer and gas delivery/removal.

The outer chamber may be vacuum, reduced pressure or desired pressure as required by the process.

The chamber may have one or more optical windows depending on the process requirements.

The chamber may have gas delivery system for delivering process and inert gases into the chamber may attached to the chamber or to the chamber wall.

A single wafer processing system for CVD, epitaxial deposition, thin film deposition/removal or any other wafer processing the chip requires system consists of a vacuum vessel with cooled or not cooled chamber wall with single or double wall, connected directly or through at least one gate valve to a chamber with multistage wafer handling mechanism for wafer delivery/removal, a shield surrounding the wafer processing area, process and inert gas delivery system with all appropriate valves attached to the chamber and having an delivery tube extending into wafer area, vacuum pumping system connected to the chamber, inside and/or outside heater directing heat into the process area employing one or more members consisting of silicon, silicon and germanium, SiₓGe₁₋ₓ solid solution, silicon and Silicon Carbide Sₓ(SiC)₁₋ₓ, Silicon and silicon dioxide Sₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves, or made from composite material (in all cases 0≦x≦1), employing at least one epitaxial chamber made by the method described herein.

While the invention has been described with reference to specific embodiments, modifications and variations of the invention may be constructed without departing from the scope of the invention, which is defined in the following claims.

I claim:

1. Apparatus for forging a body comprising an enclosure having a mold, forging material provided in the mold, and a forged product formed from the forging material in the mold at a predetermined temperature.

2. The apparatus of claim 1, wherein the enclosure is a heated enclosure having a chamber for housing the mold, a chamber heater, a ram heater and an anvil heater in the enclosure, a multiport coupled to the chamber for supplying material to the chamber, and a line coupled to the chamber for removing exhaust gases.

3. The apparatus of claim 2, wherein the multiport is an inlet/outlet multiport.

4. The apparatus of claim 2, wherein the line is a vacuum/vent line.

5. The apparatus of claim 2, wherein the forged product is a monocrystal, polycrystal or amorphous body.

6. The apparatus of claim 1, wherein the predetermined temperature ranges between about 400° C. and about a melting point of the body.

7. The apparatus of claim 1, wherein the predetermined temperature is not greater than about 400° C.

8. The apparatus of claim 1, wherein the predetermined temperature is not greater than a melting point of a lowest melting phase in the body.

9. The apparatus of claim 5, wherein the body is forged at a temperature of about 400° C.

10. The apparatus of claim 5, wherein the body is forged at a temperature of about 600° C.

11. The apparatus of claim 5, wherein the body is forged at a temperature of about 800° C.

12. The apparatus of claim 5, wherein the body is of polycrystalline material.

13. The apparatus of claim 1, wherein the body is of amorphous material.

14. The apparatus of claim 5, wherein the body comprises single crystalline, polycrystalline and amorphous portions.

15. The apparatus of claim 2, wherein the product is formed in an atmosphere having a predetermined pressure in the chamber.

16. The apparatus of claim 15, wherein the atmosphere is selected from a group consisting of vacuum, reduced pressure, inert atmosphere, reactive atmosphere, and combinations thereof.

17. The apparatus of claim 15, wherein the atmosphere is reactive atmosphere

18. The apparatus of claim 17, wherein the reactive atmosphere is selected from a group consisting of plasma, reactive gases, solids, and combinations thereof.

19. The apparatus of claim 15, wherein the body is formed by purification of the forging material.

20. The apparatus of claim 1, wherein the forging material is a powder.

21. The apparatus of claim 20, wherein the powder comprises constituents selected from a group consisting of silicon, silicon compound comprising at least one atom of silicon, silicon and germanium, SiₓGe₁₋ₓ solid solution, silicon and silicon carbide Sₓ(SiC)₁₋ₓ, silicon and silicon dioxide Siₓ(SiO₂)₁₋ₓ, silicon and ceramic, silicon and any oxide Sₓ(Oxide)₁₋ₓ, silicon and any metal SiₓM₁₋ₓ, silicon and any alloy SiₓA₁₋ₓ, and combinations thereof.

22. The apparatus of claim 21, wherein the anvil has a temperature during forging between at least about room temperature and lower than a melting point of at least one of the constituents forming the crystal R_{T}≦T≦T_{M}.

23. The apparatus of claim 22, wherein the temperature is about 400° C.≦T≦800° C.

24. The apparatus of claim 22, wherein the temperature is about 200° C.≦T≦1000° C.

25. The apparatus of claim 22, wherein the temperature is about 200° C.≦T≦1200° C.

26. The apparatus of claim 22, wherein the temperature is not greater than about 200° C.

27. The apparatus of claim 26, wherein the temperature is not lesser than about 1200° C.

28. The apparatus of any of the preceding claims, wherein the body is forged in vacuum, reduced pressure or inert atmosphere having desired pressure.

29. The apparatus of any of the preceding claims, wherein the body is forged in vacuum, reduced pressure or reactive atmosphere having desired pressure.

30. The apparatus of claim 29, wherein the reactive atmosphere is selected from a group consisting of plasma, reactive gases, solids and combinations thereof and wherein a process of purification is administered.

31. The apparatus of any of the preceding claims, wherein the powder forged is silicon powder or shot having various grain sizes from sub-micron to large shot sizes of several millimeters or larger or the powder forged is silicon compound comprising at least one atom of silicon.

32. The apparatus of claim 31, wherein the powder forged is silicon powder and germanium powder or shot having various grain sizes from sub-micron to rather large shot sizes of several millimeters or larger.

33. The apparatus of claim 31, wherein the powder forged is silicon powder and SiₓGe₁₋ₓ (0≦x≦1) powder or shot having various grain sizes from sub-micron to rather large shot sizes of several millimeters or larger.

34. The apparatus of claim 31, wherein the powder forged is silicon powder and silicon carbide, Sₓ(SiC)₁₋ₓ (0≦x≦1) powder or shot having various grain sizes from sub-micron to rather large shot sizes of several millimeters or larger.

35. The apparatus of claim 31, wherein the powder forged is silicon powder and silicon dioxide, Siₓ(SiO₂)₁₋ₓ (0≦x≦1) powder or shot having various grain sizes from sub-micron to rather large shot sizes of several millimeters or larger.

36. The apparatus of claim 31, wherein the powder forged is silicon powder and metal, SiₓM₁₋ₓ (0≦x≦1) powder or shot having various grain sizes from sub-micron to rather large shot sizes of several millimeters or larger.

37. The apparatus of claim 31, wherein the powder forged is silicon powder and Sₓ(Alloy)₁₋ₓ (0≦x≦1) powder or shot having various grain sizes from sub-micron to rather large shot sizes of several millimeters or larger.

38. The apparatus of claim 31, wherein the powder forged is silicon powder and/or metal and/or ceramic and/or alloy and/or oxide and/or any suitable additive powder or shot having various grain sizes from sub-micron to rather large shot sizes of several millimeters or larger.

39. The apparatus of claim 2, wherein the forging apparatus comprises an anvil, a ram and a mold for forging the crystal.

40. The apparatus of claim 39, wherein each part in the enclosure is independently heated.

41. The apparatus of claim 39, wherein the enclosure is heated from all sides.

42. The apparatus of claim 39, wherein the enclosure is enclosed fully or partially in a vacuum, reduced pressure or desired pressure chamber, and wherein the chamber is filled with inert gas, reactive gas or plasma gas.

43. An extrusion apparatus for extruding a body, wherein the body has a temperature between 400° C. and near melting point.

44. The apparatus of claim 43, wherein the temperature is less than 400° C. or from 400° C. to a melting point of a lowest melting phase in the body being extruded.

45. The apparats of claim 43, further comprising an extrusion chamber for holding powder and forming an extruded body, further comprising a refill hopper for delivering material to be extruded from a material delivery assembly.

46. The apparatus of claim 45, further comprising a piston and a tube shaper for forcing the extruded body through the tube shaper.

47. The apparatus of claim 46, further comprising a surrounding chamber having a cooled wall and an internal heater, the chamber being coupled to a gas inlet/outlet multiport and a vacuum/vent line.

48. The apparatus of any of the preceding claims 43 to 47, wherein the body is extruded at a temperature of about 400° C.

49. The apparatus of any of the preceding claims 43 to 48, wherein the body is extruded at a temperature of about 600° C.

50. The apparatus of any of the preceding claims 43 to 49, wherein the body is extruded at a temperature of about 800° C.

51. The apparatus of any of the preceding claims 43 to 50, wherein the extruded body is monocrystal or polycrystalline material having at least one atom of silicon.

52. The apparatus of any of the preceding claims 43 to 51, wherein the extruded body is amorphous material having at least one atom of silicon.

53. The apparatus of any of the preceding claims 43 to 52, wherein the extruded body comprises single crystalline portion and polycrystalline portion and amorphous portion.

54. The apparatus of any of the preceding claims 43 to 53, wherein the extruding is in vacuum, reduced pressure or inert atmosphere having desired pressure.

55. The apparatus of any of the preceding claims 43 to 54, wherein the extruding is in vacuum, reduced pressure or reactive atmosphere having desired pressure.

56. The apparatus of any of the preceding claims 43 to 55, wherein the reactive atmosphere is plasma, reactive gases or solid and a process of purification is administered.

57. The apparatus of any of the preceding claims 43 to 56, wherein the extruding powder is selected from a group consisting of silicon, silicon compound comprising at least one atom of silicon, silicon and germanium, SiₓGe₁₋ₓ solid solution, silicon and silicon carbide Sₓ(SiC)₁₋ₓ, silicon and silicon dioxide Siₓ(SiO₂)₁₋ₓ, silicon and any ceramic, silicon and any oxide Siₓ(Oxide)₁₋ₓ, silicon and any metal SiₓM₁₋ₓ, silicon and any alloy SiₓA₁₋ₓ, any combination between themselves at temperature equal or greater than room temperature and lower than the melting point of one or more constituents of the pressed body R_{T}≦T≦T_{M}.

58. The apparatus of any of the preceding claims 43 to 57, wherein the temperature is about 400° C.≦T≦800° C.

59. The apparatus of any of the preceding claims 43 to 58, wherein the temperature is about 200° C.≦T≦1000° C.

60. The apparatus of any of the preceding claims 43 to 59, wherein the temperature is about 200° C.≦T≦1200° C.

61. The apparatus of any of the preceding claims 43 to 60, wherein the temperature is smaller than 200° C. or greater than 1200° C.

62. The apparatus of any of the preceding claims 43 to 61, wherein the extruding is in vacuum, reduced pressure or inert atmosphere having desired pressure.

63. The apparatus of any of the preceding claims 43 to 62, wherein the extruding is in vacuum, reduced pressure or reactive atmosphere having desired pressure.

64. The apparatus of any of the preceding claims 43 to 63, wherein the reactive atmosphere is plasma, reactive gases or solid and a process of purification is administered.

65. The apparatus of any of the preceding claims 43 to 64, wherein the powder is silicon powder or shot having various grain sizes from sub-micron to rather large shot sizes of several millimeters or larger or silicon compound comprising at least one atom of silicon.

66. The apparatus of any of the preceding claims 43 to 65, wherein the powder is silicon powder and germanium powder or shot having various grain sizes from sub-micron to rather large shot sizes of several millimeters or larger.

67. The apparatus of any of the preceding claims 43 to 66, wherein the powder is silicon powder and SiₓGe₁₋ₓ (0≦x≦1) powder or shot having various grain sizes from sub-micron to rather large shot sizes of several millimeters or larger.

68. The apparatus of any of the preceding claims 43 to 67, wherein the powder is silicon powder and silicon carbide, Siₓ(SiC)₁₋ₓ (0≦x≦1) powder or shot having various grain sizes from sub-micron to rather large shot sizes of several millimeters or larger.

69. The apparatus of any of the preceding claims 43 to 68, wherein the powder is silicon powder and silicon dioxide, Siₓ(SiO₂)₁₋ₓ, (0≦x≦1) powder or shot having various grain sizes from sub-micron to rather large shot sizes of several millimeters or larger.

70. The apparatus of any of the preceding claims 43 to 69, wherein the powder is silicon powder and metal, SiₓM₁₋ₓ (0≦x≦1) powder or shot having various grain sizes from sub-micron to rather large shot sizes of several millimeters or larger.

71. The apparatus of any of the preceding claims 43 to 70, wherein the powder is silicon powder and Sₓ(Alloy)₁₋ₓ (0≦x≦1) powder or shot having various grain sizes from sub-micron to rather large shot sizes of several millimeters or larger.

72. The apparatus of any of the preceding claims 43 to 71, wherein the powder is silicon powder and/or metal and/or ceramic and/or alloy and or oxide and/or any suitable additive powder or shot having various grain sizes from sub-micron to rather large shot sizes of several millimeters or larger.

73. The apparatus of any of the preceding claims 43 to 72, wherein the powder forged is silicon powder and/or metal and/or ceramic and/or alloy and/or oxide and/or any suitable additive powder or shot having various grain sizes from sub-micron to rather large shot sizes of several millimeters or larger.

74. The apparatus of any of the preceding claims 43 to 73, wherein the forging apparatus comprises an anvil, a ram and a mold for forging the crystal.

75. The apparatus of any of the preceding claims 43 to 74, wherein each part in the enclosure is independently heated.

76. The apparatus of any of the preceding claims 43 to 75, wherein the enclosure is heated from all sides.

77. The apparatus of any of the preceding claims 43 to 76, wherein the enclosure is enclosed fully or partially in a vacuum, reduced pressure or desired pressure chamber, and wherein the chamber is filled with inert gas, reactive gas or plasma gas.

78. Apparatus for plasma deposition comprising at least one substrate, material for deposition on the substrate, plasma generators or sources for the material, and a gas and a powder input system, wherein the substrate is a hollow tube or a solid body.

79. The apparatus of claim 78, wherein the substrate is one or a plurality of substrates and wherein plasma heated softened particles strike and stick to the substrate and form layers as the one or the plurality of substrates are rotated and/or translated.

80. The apparatus of claim 79, further comprising a chamber surrounding the deposition, wherein the substrate and/or the chamber are heated.

81. The apparatus of any of preceding claims 78 to 80, further comprising gas inlet/outlet multiport and vacuum/vent line coupled to the chamber.

82. The apparatus of any of preceding claims 78 to 81, further comprising one or more plasma generators or plasma sources, gas input system, powder input system, vacuum chamber, with or without one or more chamber heating elements, and the substrate with or without heating elements.

83. The apparatus of any of preceding claims 78 to 82, further comprising one or more deposition ports in the chamber.

84. The apparatus of any of preceding claims 78 to 83, wherein substrate has rotation and/or translation mechanisms.

85. The apparatus of any of preceding claims 78 to 84, wherein the chamber has rotation and/or translation mechanisms.

86. The apparatus of any of preceding claims 78 to 85, wherein the plasma assisted deposition of powder comprises powder selected from a group consisting of silicon, silicon compound comprising at least one atom of silicon, silicon and germanium, SiₓGe₁₋ₓ solid solution, silicon and Silicon Carbide Sₓ(SiC)₁₋ₓ, Silicon and silicon dioxide Siₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves at temperature equal or greater than room temperature and lower than the melting point of one or more constituents of the deposited body R_{T}≦T≦T_{M}.

87. The apparatus of any of preceding claims 78 to 86, wherein, the powder is deposited under vacuum, reduced pressure, reactive atmosphere, inert gas, plasma, and any combinations thereof.

88. The apparatus of any of preceding claims 78 to 87, wherein the deposition is in inert atmosphere having desired pressure.

89. The apparatus of any of preceding claims 78 to 88, wherein the reactive atmosphere is plasma, reactive gases or solid and a process of purification is administered.

90. The apparatus of any of preceding claims 78 to 89, wherein a temperature in the chamber is between temperature equal to or greater than room temperature and lower than the melting point of one or more constituents of the deposited body R_{T}≦T≦T_{M}.

91. The apparatus of any of preceding claims 78 to 90, wherein the temperature in the chamber is about 400° C.≦T≦800° C.

92. The apparatus of any of preceding claims 78 to 90, wherein the temperature in the chamber is about 200° C.≦T<1000° C.

93. The apparatus of any of preceding claims 78 to 90, wherein the temperature in the chamber is about 200° C.≦T≦1200° C.

94. The apparatus of any of preceding claims 78 to 90, wherein the temperature is smaller than 200° C. or greater than 1200° C.

95. The apparatus of any of preceding claims 78 to 90, wherein the temperature of the substrate is between temperature equal to or greater than room temperature and lower than the melting point of one or more constituents of the deposited body R_{T}≦T≦T_{M}.

96. The apparatus of any of preceding claims 78 to 95, wherein the temperature of the substrate is about 400° C.≦T<800° C.

97. The apparatus of any of preceding claims 78 to 95, wherein the temperature of the substrate is about 200° C.≦T≦100° C.

98. The apparatus of any of preceding claims 78 to 95, wherein the temperature of the substrate is about 200° C.≦T≦1200° C.

99. The apparatus of any of preceding claims 78 to 95, wherein the temperature is smaller than 200° C. or greater than 1200° C.

100. Deposition apparatus for spraying of powder, powder and organic and/or inorganic base material, powder and gaseous material comprising a substrate, plurality of sprayers positioned to spray at least one portion of one side, and heating elements for heating the substrate at least from one side.

101. The apparatus of claim 100, wherein the substrate is rotated, and the substrate or slurry delivery tubes translate the sprayer, and wherein spray heated powder is heated and softened by heaters.

102. The apparatus of claim 101, wherein the powder is selected from a group consisting of silicon, silicon compound comprising at least one atom of silicon, silicon and germanium, Siₓ-Ge₁₋ₓ solid solution, silicon and Silicon Carbide Siₓ(SiC)₁₋ₓ, silicon and silicon dioxide Siₓ(SiO₂)₁₋ₓ, silicon and any ceramic, silicon and any oxide Siₓ(Oxide)₁₋ₓ, silicon and any metal SiₓM₁₋ₓ, silicon and any alloy SiₓA₁₋ₓ, any combination between themselves at temperature equal to or greater than room temperature and lower than the melting point of one or more constituents of the deposited body R_{T}≦T≦T_{M}.

103. The apparatus of any of preceding claims 100 to 102, wherein the substrate is tubular having any cross-section, planar, flat, curved or have any desired shape or form suitable for a particular application.

104. The apparatus of any of preceding claims 100 to 103, wherein the substrate comprises at least one element and wherein the substrate is rotated and translated.

105. The apparatus of any of preceding claims 100 to 104, wherein the substrate is heated from inside and/or outside, and wherein each substrate is independently heated.

106. The apparatus of any of preceding claims 100 to 105, wherein the sprayers are one or more sprayers and they are oscillated, rotated and translated in relation to themselves and to the substrate on which the deposition takes place, and wherein each sprayer delivers same or different compounds for spraying of a premixed compound or provides for compound formation on a surface of the substrate.

107. The apparatus of any of preceding claims 100 to 106, wherein the apparatus is enclosed in vacuum, reduced pressure or any process suitable chamber that has vacuum and vent valves and gas delivery system.

108. The apparatus of any of preceding claims 100 to 107, wherein the deposition process is under vacuum, reduced pressure, reactive gas, inert gas, plasma, and any combinations thereof.

109. The apparatus of any of preceding claims 100 to 108, wherein the process is in inert atmosphere having desired pressure.

110. The apparatus of any of preceding claims 100 to 109, wherein the reactive atmosphere is plasma, reactive gases or solid, and wherein a process of purification is administered.

111. The apparatus of any of preceding claims 100 to 110, wherein a temperature in the chamber and a substrate temperature are between temperature equal to or greater than room temperature and lower than the melting point of one or more constituents of the deposited body R_{T}≦T≦T_{M}.

112. The apparatus of any of preceding claims 100 to 111, wherein the temperature in the chamber is about 400° C.≦T≦800° C.

113. The apparatus of any of preceding claims 100 to 111, wherein temperature in the chamber is about 200° C.≦T≦1000° C.

114. The apparatus of any of preceding claims 100 to 111, wherein temperature in the chamber is about 200° C.≦T≦1200° C.

115. The apparatus of any of preceding claims 100 to 111, wherein temperature in the chamber is smaller than 200° C. or greater than 1200° C.

116. The apparatus of any of preceding claims 100 to 111, wherein temperature of the substrate is between temperature equal to or greater than room temperature and lower than the melting point of one or more constituents of the deposited body R_{T}≦T≦T_{M}.

117. The apparatus of any of preceding claims 100 to 116, wherein temperature of the substrate is about 400° C.≦T≦800° C.

118. The apparatus of any of preceding claims 100 to 116, wherein temperature of the substrate is about 200° C.≦T≦1000° C.

119. The apparatus of any of preceding claims 100 to 116, wherein temperature of the substrate is about 200° C.≦T≦1200° C.

120. The apparatus of any of preceding claims 100 to 116, wherein temperature of the substrate is smaller than 200° C. or greater than 1200° C.

121. Apparatus for making tubular members having any cross section, any length and any desired shape or form comprising a body within or without a mold, a heater covering part of the mold and a chamber fully or partially surrounding at least one member and heating elements.

122. The apparatus of claim 121, wherein the chamber has a gas inlet/outlet multiport and a vacuum/vent line.

123. The apparatus of claim 122, further comprising a silicon or a silicon containing compound preform placed in the heated chamber.

124. The apparatus of claim 123, wherein the preform is rotated and a heated ring is translated along the preform for sintering or melting the material and forming a solid product.

125. The apparatus of any of preceding claims 121 to 124, wherein the chamber is a vacuum, low pressure or pressure chamber.

126. The apparatus of any of preceding claims 121 to 125, wherein the chamber surrounding the member and the heating elements is absent.

127. The apparatus of any of preceding claims 121 to 126, wherein the member is rotated and/or translated.

128. The apparatus of any of preceding claims 121 to 127, wherein the member is heated from inside and/or outside.

129. The apparatus of any of preceding claims 121 to 128, wherein the member is heated from outside by chamber heaters and a zone heater for directional or non-directional processing.

130. The apparatus of any of preceding claims 121 to 129, wherein the chamber has vacuum and/or vent valves.

131. The apparatus of any of preceding claims 121 to 130, wherein the chamber has a gas inlet/outlet multiport.

132. The apparatus of any of preceding claims 121 to 131, wherein the chamber has one or more plasma source attached.

133. The apparatus of any of preceding claims 121 to 132, wherein the material processed is solid material, powder, powder and organic or inorganic base material, powder and gaseous material.

134. The apparatus of any of preceding claims 121 to 133, wherein the powder is selected from a group consisting of silicon, silicon compound comprising at least one atom of silicon, silicon and germanium, SiₓGe₁₋ₓ solid solution, silicon and Silicon Carbide Sₓ(SiC)₁₋ₓ, Silicon and silicon dioxide Siₓ(SiO₂)₁₋ₓ, silicon and any ceramic, silicon and any oxide Sₓ(Oxide)₁₋ₓ, silicon and any metal SiₓM₁₋ₓ, Silicon and any alloy SiₓA₁₋ₓ, any combination between themselves at temperature equal or greater than room temperature and lower than the melting point of one or more constituents of the deposited body R_{T}≦T≦T_{M}.

135. The apparatus of any of preceding claims 121 to 134, further comprising at least one substrate, plurality of sprayers positioned to spray at least one portion of one side, and heating elements for heating the substrate at least from one side.

136. The apparatus of any of preceding claims 121 to 135, wherein the substrate is tubular having any cross-section, planar or have any desired shape or form suitable for a particular application.

137. The apparatus of any of preceding claims 121 to 136, wherein processing of the material is under vacuum, reduced pressure, reactive gas, inert gas, plasma, and any combinations thereof.

138. The apparatus of any of preceding claims 121 to 137, wherein processing of the material is in inert atmosphere having desired pressure.

139. The apparatus of any of preceding claims 121 to 138, wherein the reactive atmosphere is plasma, reactive gases or solid, and wherein a process of purification is administered.

140. The apparatus of any of preceding claims 121 to 139, wherein the process temperature is between temperature equal to or greater than room temperature and lower than a melting point of one or more constituents of the deposited body R_{T}≦T≦T_{M}.

141. The apparatus of any of preceding claims 121 to 140, wherein the process temperature is about 400° C.≦T≦800° C.

142. The apparatus of any of preceding claims 121 to 140, wherein the process temperature is about 200° C.≦T≦1000° C.

143. The apparatus of any of preceding claims 121 to 140, wherein the process temperature is about 200° C.≦T≦1200° C. The temperature is smaller than 200° C. or greater than 1200° C.

144. The apparatus of any of preceding claims 121 to 143, wherein the temperature of the substrate is between temperature equal or greater than room temperature and lower than the melting point of one or more constituents of the deposited body R_{T}≦T≦T_{M}.

145. The apparatus of any of preceding claims 121 to 144, wherein the temperature of the substrate is about 400° C.≦T≦800° C.

146. The apparatus of any of preceding claims 121 to 144, wherein the temperature of the substrate is about 200° C.≦T≦1000° C.

147. The apparatus of any of preceding claims 121 to 144, wherein the temperature of the substrate is about 200° C.≦T≦1200° C.

148. The apparatus of any of preceding claims 121 to 144, wherein the temperature is smaller than 200° C. or greater than 1200° C.

149. The apparatus of any of preceding claims 121 to 148, wherein the member is tubular and has any cross section such as round, elliptical, rectangular, polygonal or any other shape.

150. The apparatus of any of preceding claims 121 to 149, wherein the member has uneven thickness pattern over its entire surface.

151. The apparatus of any of preceding claims 121 to 150, wherein the member has different composition and density over the entire body.

152. The apparatus of any of preceding claims 121 to 151, wherein the member has different composition and density over its thickness.

153. The apparatus of any of preceding claims 121 to 152, wherein the composition and material properties is layered over any dimension of the member such as length, thickness, width, radius, etc.

154. A preform comprising a horizontal or vertical wafer processing boat preform comprising a plurality of protrusions for fabrication of slots for wafers and openings for gas flow between the wafers to enable deposition of even thickness.

155. The preform of claim 154, wherein the wafer boat preform is made of material selected from a group consisting of silicon, silicon compound comprising at least one atom of silicon, silicon and germanium, SiₓGe₁₋ₓ solid solution, silicon and silicon carbide Siₓ(SiC)₁₋ₓ, Silicon and silicon dioxide Siₓ(SiO₂)₁₋ₓ, silicon and any ceramic, silicon and any oxide Sₓ(Oxide)₁₋ₓ, silicon and any metal SiₓM₁₋ₓ, Silicon and any alloy SiₓA₁₋ₓ, any combination between themselves, or made from composite material, wherein 0≦x≦1.

156. The preform of claim 154, wherein the wafer boat preform is made by layering one or more of the following materials: Si, silicon compound comprising at least one silicon atom, SiₓGe₁₋ₓ, SiC, Siₓ(SiC)₁₋ₓ, Siₓ(SiO₂)₁₋ₓ, Siₓ(Oxide)₁₋ₓ, SiₓM₁₋ₓ, composite material, and any combination or order between themselves, wherein 0≦x≦1.

157. The preform of any of preceding claims 154 to 156, wherein the wafer boat preform has closed ends at a base and a top that are half or full discs and end discs having outer diameters equal or greater than an outer diameter of the wafer boat.

158. The preform of any of preceding claims 154 to 157, wherein the end discs are solid discs.

159. The preform of any of preceding claims 154 to 158, wherein the end discs have certain portions removed.

160. The preform of any of preceding claims 154 to 159, wherein the wafer boat preform is fabricated from material selected from a group consisting of silicon, silicon compound comprising at least one silicon atom, silicon and germanium, SiₓGe₁₋ₓ solid solution, silicon and Silicon Carbide Sₓ(SiC)₁₋ₓ, Silicon and silicon dioxide Sₓ(SiO₂)₁₋ₓ, silicon and any ceramic, silicon and any oxide Siₓ(Oxide)1-x, silicon and any metal SiₓM₁₋ₓ, Silicon and any alloy SiₓA₁₋ₓ, any combination between themselves, or made from composite material, wherein 0≦x≦1.

161. The preform of any of preceding claims 154 to 160, wherein the wafer boat preform is fabricated by heating and melting or sintering a boat fabrication material using a mold or prefabricated using a mold having desired shape and form, or transferring it to the mold, solidifying it, cooling it down at a desired cool-down regime, machining it to a desired tolerance, and sintering it using process defined parameters.

162. The preform of any of preceding claims 154 to 161, wherein the boat fabrication material is powder mixed with organic and/or inorganic compounds for shaping purposes.

163. The preform of any of preceding claims 154 to 161, wherein the boat fabrication material is solid material.

164. The preform of any of preceding claims 154 to 163, wherein the melting or sintering is done in a vacuum chamber.

165. The preform of any of preceding claims 154 to 164, wherein the melting or sintering is done under reduced or high pressure of inert or reactive gas.

166. The preform of any of preceding claims 154 to 165, wherein the reactive gas is mixture between atomic or charged molecular state gas such as plasma gas and a neutral inert or reactive gas.

167. The preform of any of preceding claims 154 to 167, wherein the melting or sintering is preceded by one or more steps of purging and purification.

168. Wafer boat preform comprising boat fabrication material selected from a group consisting of silicon, silicon compound comprising at least one silicon atom, silicon and germanium, SiₓGe₁₋ₓ solid solution, silicon and Silicon Carbide Sₓ(SiC)₁₋ₓ, Silicon and silicon dioxide Siₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves, or made from composite material, wherein 0≦x≦1.

169. The wafer boat preform of claim 168, wherein the boat is made by pressing the boat fabrication material within a die having desired shape and form, sintering, cooling it down at a desired cool-down regime, and machining it to a desired tolerance.

170. The wafer boat preform of claim 169, wherein the boat fabrication material is powder mixed with organic and/or inorganic compounds for shaping purposes.

171. The wafer boat preform of claim 169, wherein the boat fabrication material is solid material.

172. The wafer boat preform of any of preceding claims 168 to 171, wherein the pressing is done in a vacuum chamber.

173. The wafer boat preform of any of preceding claims 168 to 171, wherein the pressing is done under reduced or high pressure of inert or reactive gas.

174. The wafer boat preform of any of preceding claims 168 to 173, wherein the reactive gas is mixture between atomic or charged molecular state gas such as plasma gas and a neutral inert or reactive gas.

175. The wafer boat preform of any of preceding claims 168 to 174, wherein the melting or sintering is preceded by one or more steps of purging and purification.

176. A process for fabrication of wafer boat preforms consisting of providing a boat fabrication material selected from a group consisting of silicon, silicon compound comprising at least one silicon atom, silicon and germanium, SiₓGe₁₋ₓ solid solution, silicon and silicon carbide Siₓ(SiC)₁₋ₓ, Silicon and silicon dioxide Sₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves, or made from composite material, wherein 0≦x≦1.

177. The process of claim 176, further comprising extruding the fabrication material within a die having desired shape and form, sintering, cooling it down at a desired cool-down regime, and machining it to a desired tolerance.

178. The process of claim 177, wherein the boat fabrication material is powder.

179. The process of claim 178, wherein the boat fabrication material is powder mixed with organic or inorganic materials.

180. The process of claim 178, wherein the boat fabrication material is solid material.

181. The process of any of preceding claims 176 to 180, wherein the pressing is done in a vacuum chamber.

182. The process of any of preceding claims 176 to 181, wherein the pressing is done under reduced or high pressure of inert or reactive gas.

183. The process of any of preceding claims 176 to 182, wherein the reactive gas is a mixture between atomic or charged molecular state gas such as plasma gas and a neutral inert or reactive gas.

184. The process of any of preceding claims 176 to 183, wherein the melting or sintering is preceded by one or more steps of purging and purification.

185. Process for fabrication of a member having shape of tube, plate, rod or any other shape or form consisting of providing a material selected from a group consisting of silicon, silicon compound comprising at least one silicon atom, silicon and germanium, SiₓGe₁₋ₓ solid solution, silicon and silicon carbide Siₓ(SiC)₁₋ₓ, silicon and silicon dioxide Siₓ(SiO₂)_{1-X}, silicon and any ceramic, silicon and any oxide Sₓ(Oxide)₁₋ₓ, silicon and any metal SiₓM₁₋ₓ, Silicon and any alloy SiₓA₋ₓ, any combination between themselves, or made from composite material, wherein 0≦x≦1.

186. The process of claim 185, further comprising heating and melting or sintering the material made with a mold having desired shape and form, or transferring the material to the mold, solidifying it, cooling it down at a desired cool-down regime, removing the mold, machining it to the desired tolerance, and sintering again.

187. The process of claim 186, wherein the material is powder mixed with organic or inorganic materials.

188. The process of claim 186, wherein the material is solid material.

189. The process of any of preceding claims 185 to 188, wherein the melting is done in a vacuum chamber.

190. The process of any of preceding claims 185 to 188, wherein the melting or sintering is done under reduced or high pressure of inert or reactive gas.

191. The process of any of preceding claims 185 to 190, wherein the reactive gas is a mixture between atomic or charged molecular state gas such as plasma gas and a neutral inert or reactive gas.

192. The process of any of preceding claims 185 to 191, wherein the melting or sintering is preceded by one or more steps of purging and purification.

193. The process of any of preceding claims 185 to 192, further comprising fabricating wafer boat members having shape of tube, plate, rod or any other shape.

194. The process of any of preceding claims 185 to 193, further comprising cutting the member or solidified boat in two along medial lines, forming openings in cylindrical walls, coating and fusing depositing material on top of base material.

195. The process of any of preceding claims 185 to 194, further comprising forming two boats by melting or molding or casting or hot pressing and sintering the powder material.

196. The process of any of preceding claims 185 to 195, further comprising forming slots in inward and/or outward ribs or extensions, forming ends of the boats having complementary steps to connect the boats end-to-end in an axial stack or row.

197. Fabrication process comprising the steps of providing with a powder or solid, heating the powder or the solid to a plastic slate and forming a tube, plate or rod.

198. The process of claim 197, further comprising forming a chamber liner and applying to a process chamber, forming a chemical vapor deposition (CVD) station, halving formed tubes lengthwise, cutting windows, inward ribs or extensions in the tubes, or the inner walls are slotted, forming a vertical boat, and in parallel steps cutting windows, plotting the boat and forming a horizontal boat.

199. The process of claim 198, wherein the powder is mixed with organic or inorganic material.

200. The process of claim 198, wherein the powder is selected from a group consisting of silicon, silicon compound containing at least one atom of silicon, silicon and germanium, SiₓGe₁₋ₓ solid solution, silicon and Silicon Carbide Sₓ(SiC)₁₋ₓ, Silicon and silicon dioxide Sₓ(SiO₂)₁₋ₓ, silicon and any ceramic, silicon and any oxide Sₓ(Oxide)₁₋ₓ, silicon and any metal SiₓM₁₋ₓ, Silicon and any alloy SiₓA₁₋ₓ, any combination between themselves, or made from composite material, wherein 0≦x≦1.

201. Wafer processing apparatus comprising a processing chamber, wafer handling tools, wafer boat handling tools consisting of one or more processing chambers, shields and enclosures employing one or more members, and at least one member made of material containing at least one atom of silicon.

202. The apparatus of claim 201, wherein the at least one member is of material selected from a group consisting of silicon, silicon compound comprising at least one silicon atom, silicon and germanium, SiₓGe₁₋ₓ solid solution, silicon and silicon carbide Sₓ(SiC)₁₋ₓ, silicon and silicon dioxide Sₓ(SiO₂)₁₋ₓ, silicon and any ceramic, silicon and any oxide Sₓ(Oxide)₁₋ₓ, silicon and any metal SiₓM₁₋ₓ, Silicon and any alloy SiₓA₁₋ₓ, any combination between themselves, or made from composite material, wherein 0≦x≦1.

203. the apparatus of claim 202, wherein each chamber comprises separate or a common gas delivery and venting system, vacuum system, internal or external heating elements, and cooled or not cooled vacuum shell.

204. The apparatus of claim 203, wherein the vacuum shell is partially or fully lined with material selected from a group consisting of silicon, silicon compound comprising at least one silicon atom, silicon and germanium, SiₓGe₁₋ₓ solid solution, silicon and Silicon Carbide Siₓ(SiC)₁₋ₓ, Silicon and silicon dioxide Sₓ(SiO₂)₁₋ₓ, silicon and any ceramic, silicon and any oxide Sₓ(Oxide)₁₋ₓ, silicon and any metal SiₓM₁₋ₓ, Silicon and any alloy SiₓA₁₋ₓ, any combination between themselves, or made from composite material, wherein 0≦x≦1.

205. Wafer processing apparatus comprising plural processing chambers, wherein at least one of the processing chambers is a chemical vapor deposition (CVD) chamber comprising one or more members consisting of material selected from a group consisting of silicon, silicon compound comprising at least one silicon atom, silicon and germanium, SiₓGe₁₋ₓ, solid solution, silicon and Silicon Carbide Siₓ(SiC)₁₋ₓ, Silicon and silicon dioxide Sₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves, or made from composite material, wherein 0≦x≦1.

206. The apparatus of claim 205, wherein each CVD chamber comprises separate or common gas delivery and venting system, vacuum system, internal or external heating elements, and cooled or not cooled vacuum shell.

207. The apparatus of claim 206, wherein the vacuum shell is partially or fully lined with material selected from a group consisting of silicon, silicon compound comprising at least one silicon atom, silicon and germanium, SiₓGe₁₋ₓ solid solution, silicon and silicon carbide Siₓ(SiC)₁₋ₓ, silicon and silicon dioxide Siₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves, or made from composite material, wherein 0≦x≦1.

208. Wafer processing apparatus comprising plural processing chambers, wherein at least one of the processing chambers is an epitaxial chamber comprising one or more members consisting of silicon, silicon compound comprising at least one silicon atom, silicon and germanium, SiₓGe₁₋ₓ solid solution, silicon and Silicon Carbide Sₓ(SiC)₁₋ₓ, Silicon and silicon dioxide Siₓ(SiO₂)₁₋ₓ, silicon and any ceramic, silicon and any oxide Sₓ(Oxide)₁₋ₓ, silicon and any metal SiₓM₁₋ₓ, Silicon and any alloy SiₓA₁₋ₓ, any combination between themselves, or made from composite material, wherein 0≦x≦1.

209. The apparatus of claim 208, wherein each epitaxial chamber comprises separate or common gas delivery and venting system, vacuum system, internal or external heating elements, and cooled or not cooled vacuum shell.

210. The apparatus of claim 209, wherein the vacuum shell is partially or fully lined with material selected from a group consisting of silicon, silicon compound comprising at least one silicon atom, silicon and germanium, SiₓGe₁₋ₓ solid solution, silicon and Silicon Carbide Siₓ(SiC)₁₋ₓ, Silicon and silicon dioxide Sₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves, or made from composite material, wherein 0≦x≦1.

211. Wafer processing apparatus comprising plural processing chambers, wherein at least one of the processing chambers is a thin film deposition chamber comprising one or more members made of material selected from a group consisting of silicon, silicon compound comprising at least one silicon atom, silicon and germanium, SiₓGe₁₋ₓ solid solution, silicon and Silicon Carbide Sₓ(SiC)₁₋ₓ, Silicon and silicon dioxide Siₓ(SiO₂)₁₋ₓ, silicon and any ceramic, silicon and any oxide Sₓ(Oxide)₁₋ₓ, silicon and any metal SiₓM₁₋ₓ, Silicon and any alloy SiₓA₁₋ₓ, any combination between themselves, or made from composite material, wherein 0≦x≦1.

212. The apparatus of claim 211, wherein the thin film deposition chamber comprises separate or common gas delivery and venting system, vacuum system, internal or external heating elements, cooled or not cooled vacuum shell.

213. The apparatus of claim 212, wherein the vacuum shell is partially or fully lined with material selected from a group consisting of silicon, silicon compound comprising at least one silicon atom, silicon and germanium, SiₓGe₁₋ₓ solid solution, silicon and Silicon Carbide Siₓ(SiC)₁₋ₓ, Silicon and silicon dioxide Sₓ(SiO₂)₁₋ₓ, silicon and any ceramic, silicon and any oxide Sₓ(Oxide)₁₋ₓ, silicon and any metal SiₓM₁₋ₓ, Silicon and any alloy SiₓAₓ, any combination between themselves, or made from composite material, wherein all cases 0≦x≦1.

214. Wafer processing apparatus comprising plural processing chambers, wherein at least one of the processing chambers is thin film removal chamber comprising one or more members consisting of silicon, silicon compound comprising at least one silicon atom, silicon and germanium, SiₓGe₁₋ₓ solid solution, silicon and Silicon Carbide Sₓ(SiC)₁₋ₓ, Silicon and silicon dioxide Sₓ(SiO₂)₁₋ₓ, silicon and any ceramic, silicon and any oxide Sₓ(Oxide)₁₋ₓ, silicon and any metal SiₓM₁₋ₓ, Silicon and any alloy SiₓA₁₋ₓ, any combination between themselves, or made from composite material, wherein all cases 0≦x≦1.

215. The apparatus of claim 214, wherein the thin film removal chamber comprises separate or common gas delivery and venting system, vacuum system, internal or external heating elements, cooled or not cooled vacuum shell partially or fully lined with silicon, silicon-compound comprising at least one silicon atom, silicon and germanium, SiₓGe₁₋ₓ solid solution, silicon and Silicon Carbide Sₓ(SiC)₁₋ₓ, Silicon and silicon dioxide Sₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves, or made from composite material, wherein 0≦x≦1.

216. The apparatus of any of the preceding claims 201 to 215, wherein one of the chambers is a main chamber connected with other chambers directly or via one or more gate valves.

217. The apparatus of any of the preceding claims 201 to 216, wherein one or more chambers is vacuum, low pressure or desired pressure chamber.

218. The apparatus of any of the preceding claims 201 to 217, wherein one or more chambers has at least one internal or external heater.

219. The apparatus of any of the preceding claims 201 to 218, wherein one or more chambers has at least one partial or complete heat shield.

220. A chemical vapor deposition (CVD) system comprising a vacuum vessel with cooled or not cooled chamber with single or double wall, a robot handling arm having elements for wafer or wafer boat delivery/removal that forms a vacuum tight seal when the chamber is loaded, a wafer tray/boat containing one or more wafers resting on the wafer boat delivery/removal arm, a shield surrounding the wafer tray/boat and an inside portion of the wafer handling arm, process gas delivery system with all respective valves attached to the chamber and having a delivery tube extending into a wafer area, inert gas delivery system with all respective valves attached to the chamber and having a delivery tube with or without diffuser extending into the wafer area, vacuum pumping system connected to the chamber, and an inside or outside heater directing heat into the process area.

221. The system of claim 220, wherein the process area comprises one or more members of material selected from a group consisting of silicon, silicon compound comprising at least one silicon atom, silicon and germanium, SiₓGe₁₋ₓ solid solution, silicon and Silicon Carbide Siₓ(SiC)₁₋ₓ, Silicon and silicon dioxide Sₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves, or made from composite material, wherein 0≦x≦1.

222. The system of claim 221, wherein the CVD system is vertical, horizontal or of any suitable position from −90° to +90°.

223. The system of any of the preceding claims 220 to 222, wherein the wafer boat is of solid connected members made from material selected from a group consisting of silicon, silicon compound comprising at least one silicon atom, silicon and germanium, SiₓGe₁₋ₓ solid solution, silicon and Silicon Carbide Siₓ(SiC)₁₋ₓ, Silicon and silicon dioxide Siₓ(SiO₂)₁₋ₓ, silicon and any ceramic, silicon and any oxide Sₓ(Oxide)₁₋ₓ, silicon and any metal SiₓM₁₋ₓ, silicon and any alloy SiₓA₁₋ₓ, any combination between themselves, or made from composite material, wherein 0≦x≦1.

224. The system of any of the preceding claims 220 to 222, wherein the wafer boat is of modular elements made from material selected from a group consisting of silicon, silicon compound comprising at least one silicon atom, silicon and germanium, SiₓGe₁₋ₓ solid solution, silicon and silicon carbide Siₓ(SiC)₁₋ₓ, Silicon and silicon dioxide Sₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves, or made from composite material, wherein 0≦x≦1.

225. The system of any of the preceding claims 220 to 224, wherein the wafer boat comprises one or more slots for supporting wafers spaced at appropriate distances.

226. The system of any of the preceding claims 220 to 225, wherein the wafers in the boat are positioned so there is no other material between the wafers other than vacuum or any gas present in a processing part of the chamber.

227. The system of any of the preceding claims 220 to 226, wherein the wafer boats comprise slots for wafer support and susceptors between the wafers for improved temperature distribution over wafer surfaces resulting in more uniform deposited layer thickness and composition.

228. The system of any of the preceding claims 220 to 227, wherein the susceptor in the boat is part of the wafer boat.

229. The system of any of the preceding claims 220 to 227, wherein the susceptor in the boat is inserted after or prior to the boat being made, or together with the wafer loading.

230. The system of any of the preceding claims 220 to 229, wherein the boat is modular.

231. The system of any of the preceding claims 220 to 230, wherein each module of the boat comprises support for one or more wafers.

232. The system of any of the preceding claims 220 to 231, wherein each module comprises support for one or more wafers separated by inserted or built in susceptors.

233. The system of any of the preceding claims 220 to 232, wherein the susceptors are full body or have cuts to allow wafer only insertion/removal handling.

234. The system of any of the preceding claims 220 to 233, wherein the boat is made from modular parts connected via chemical or mechanical bonding.

235. The system of any of the preceding claims 220 to 234, wherein the boat has round, elliptical, polygonal or any other cross section.

236. The system of any of the preceding claims 220 to 235, wherein the boat has one or more elements at each end for mechanical strength during handling.

237. The system of any of the preceding claims 220 to 236, wherein end parts of the boat are modules.

238. The system of any of the preceding claims 220 to 237, wherein all parts of the boat are made from same or different materials.

239. A single wafer processing system for chemical vapor deposition (CVD), epitaxial deposition, thin film deposition/removal or any other wafer processing for chips comprising a vacuum vessel with cooled or not cooled chamber wall and with single or double wall, connected directly or through at least one gate valve to a chamber with multistage wafer handling mechanism for wafer delivery/removal, a shield surrounding the wafer processing area, process and inert gas delivery system with all respective valves attached to the chamber, a delivery tube extending into a wafer area, vacuum pumping system connected to the chamber, inside and/or outside heater directing heat into the process area.

240. The system of claim 239, wherein the process area comprises one or more members consisting of silicon, silicon compound comprising at least one silicon atom, silicon and germanium, SiₓGe₁₋ₓ solid solution, silicon and silicon carbide Siₓ(SiC)₁₋ₓ, silicon and silicon dioxide Siₓ(SiO₂)₁₋ₓ, silicon and any ceramic, silicon and any oxide Siₓ(Oxide)₁₋ₓ, silicon and any metal SiₓM₁₋ₓ, silicon and any alloy SiₓA₁₋ₓ, any combination between themselves, or made from composite material, wherein 0≦x≦1.

241. The system of claim 240, further comprising vacuum pumping systems and gas delivery systems for both chambers.

242. The system of claim 241, further comprising heating elements located around or in the chambers.

243. The system of claim 242, further comprising chamber connection ports connecting a chamber to additional chambers for transferring or removing the wafers.

244. The system of any of the preceding claims 239 to 243, wherein the process chamber is a CVD chamber.

245. The system of any of the preceding claims 239 to 243, wherein the process chamber is an epitaxial deposition chamber.

246. The system of any of the preceding claims 239 to 243, wherein the process chamber is a thin film deposition/removal chamber.

247. The system of any of the preceding claims 239 to 243, wherein the process chamber is a wafer process chamber.

248. The system of any of the preceding claims 239 to 247, wherein the process chamber has any cross section and height.

249. The system of any of the preceding claims 239 to 248, wherein the system is vertical, horizontal or has any suitable position from −90° to +90°.

250. The system of any of the preceding claims 239 to 249, wherein the members are made from material selected from a group consisting of silicon, silicon compound comprising at least one silicon atom, silicon and germanium, SiₓGe₁₋ₓ solid solution, silicon and silicon carbide Sₓ(SiC)₁₋ₓ, silicon and silicon dioxide Sₓ(SiO₂)₁₋ₓ, silicon and any ceramic, silicon and any oxide Siₓ(Oxide)₁₋ₓ, silicon and any metal SiₓM₁₋ₓ, silicon and any alloy SiₓA₁₋ₓ, any combination between themselves, or made from composite material, wherein 0≦x≦1.

251. The system of any of the preceding claims 239 to 250, wherein the members are solidly connected by chemical or mechanical bonding.

252. The system of any of the preceding claims 239 to 251, wherein the members are made of material selected from a group consisting of silicon, silicon compound comprising at least one silicon atom, silicon and germanium, SiₓGe₁₋ₓ, solid solution, silicon and silicon carbide Siₓ(SiC)₁₋ₓ, silicon and silicon dioxide Siₓ(SiO₂)₁₋ₓ, silicon and any ceramic, silicon and any oxide Sₓ(Oxide)₁₋ₓ, silicon and any metal SiₓM₁₋ₓ, silicon and any alloy SiₓA₁₋ₓ, any combination between themselves, or made from composite material, wherein 0≦x≦1, and wherein the members are modular.

253. The system of any of the preceding claims 239 to 251, wherein the members are made of material selected from a group consisting of silicon, silicon compound comprising at least one silicon atom, silicon and germanium, SiₓGe₁₋ₓ solid solution, silicon and Silicon Carbide Sₓ(SiC)₁₋ₓ, Silicon and silicon dioxide Siₓ(SiO₂)₁ silicon and any ceramic, silicon and any oxide Sₓ(Oxide)₁₋ₓ, silicon and any metal SiₓM₁₋ₓ, Silicon and any alloy SiₓA₁₋ₓ, any combination between themselves, or made from composite material, wherein 0≦x≦1, and comprise one or more slots for wafers' support to optimize the process.

254. The system of any of the preceding claims 239 to 253, wherein the wafer processing chamber has a susceptor next to the wafer for improved temperature distribution over the wafer surface that results in more uniform deposited layer thickness and composition.

255. The system of any of the preceding claims 239 to 254, wherein the susceptor in the process chamber is part of the chamber.

256. The system of any of the preceding claims 239 to 255, further comprising a wafer delivery arm, wherein the wafer delivery arm is made in full or partially from material selected from a group consisting of silicon, silicon compound comprising at least one silicon atom, silicon and germanium, SiₓGe₁₋ₓ solid solution, silicon and silicon carbide Sₓ(SiC)₁₋ₓ, silicon and silicon dioxide Sₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋, any combination between themselves, or made from composite material, wherein 0≦x≦1.

257. The system of any of the preceding claims 239 to 256, wherein the susceptor is a full body or has certain cuts to allow wafer only insertion/removal handling.

258. The system of any of the preceding claims 239 to 257, wherein all chamber parts are made in full or partially from material selected from a group consisting of silicon, silicon compound comprising at least one silicon atom, silicon and germanium, SiₓGe₁₋ₓ solid solution, silicon and silicon carbide Sₓ(SiC)₁₋ₓ, silicon and silicon dioxide Sₓ(SiO₂)₁₋ₓ, silicon and any ceramic, silicon and any oxide Siₓ(Oxide)₁₋ₓ, silicon and any metal SiₓM₁₋ₓ, silicon and any alloy SiₓA₁₋ₓ, any combination between themselves, or made from composite material, wherein 0≦x≦1, and are from modular parts connected via chemical or mechanical bonding or by assembling without bonding.

259. The system of any of the preceding claims 239 to 258, wherein the chamber has round, elliptical, polygonal or any other applicable cross section.

260. The system of any of the preceding claims 239 to 259, further comprising end parts of the wafer processing chamber, wherein the end parts are modules.

261. The system of any of the preceding claims 239 to 260, wherein all parts of the boat are made from the same or different materials.

262. Epitaxial/CVD chamber body comprising epitaxial/CVD chambers made in full or partially from material selected from a group consisting of silicon, silicon compound comprising at least one silicon atom, silicon and germanium, SiₓGe₁₋ₓ, solid solution, silicon and silicon carbide Sₓ(SiC)₁₋ₓ, silicon and silicon dioxide Sₓ(SiO₂)₁₋ₓ, silicon and any ceramic, silicon and any oxide Sₓ(Oxide)₁₋ₓ, silicon and any metal SiₓM₁₋ₓ, silicon and any alloy SiₓA₁₋ₓ, any combination between themselves, or made from composite material, wherein 0≦x≦1.

263. The chamber body of claim 262, further comprising bodies, an optical window for wafer radiation and at least one opening for wafer and gas delivery/removal.

264. The chamber body of claim 263, wherein the bodies are bonded together along side edges forming the chamber, a wafer heater accesses wafers in the chamber through the window, and a wafer lifting and rotating mechanism port and assembly supports wafers through an opposite window.

265. The chamber body of any of the preceding claims 262 to 264, wherein the chambers have suitable wall thicknesses and at least one infrared window at each side, hollow interior and at least one gate opening for connection to a wafer supply and process gas supply chamber and a gas exhaust.

266. The chamber body of any of the preceding claims 262 to 265, wherein the chamber is made from materials selected from a group consisting of silicon, silicon compound comprising at least one silicon atom, silicon and germanium, SiₓGe₁₋ₓ solid solution, silicon and silicon carbide Sₓ(SiC)₁₋ₓ, silicon and silicon dioxide Siₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves, or made from composite material, wherein 0≦x≦1.

267. The chamber body of any of the preceding claims 262 to 266, wherein the epitaxial chamber body comprises a single body made by pressing of material, machining it from inside and out in its green state, purifying the said body at a certain temperature by immersing it in a chemically reactive gas, plasma or liquid for certain period of time, sintering the said body at appropriate temperature determined by its composition, final machining of the said body, if needed, to meet the specifications of the epitaxial deposition process.

268. The chamber body of claim 267, wherein the finished body is subjected to thin film deposition such as chemical vapor deposition, plasma enhanced deposition, or other suitable deposition method for better finish on the inside and outside.

269. The chamber body of any of the preceding claims 262 to 266, wherein the epitaxial chamber body comprises a single body made by casting of the material, machining it from inside and out in its green state, purifying said body at a certain temperature by immersing it in a chemically reactive gas, plasma or liquid for certain period of time, sintering the said body at appropriate temperature determined by its composition, final machining of the said body, if needed, to meet the specifications of the epitaxial deposition process.

270. The chamber body of claim 269, wherein the finished body is subjected to thin film deposition such as chemical vapor deposition, plasma enhanced deposition, or other suitable deposition method for better finish on the inside and outside.

271. The chamber body of any of the preceding claims 262 to 266, wherein the epitaxial chamber comprises upper and lower parts made by casting to shape the material, machining the parts, purifying the said body at a certain temperature by immersing it in a chemically reactive gas, plasma or liquid for certain period of time, sintering the said body at appropriate temperature determined by its composition, joining the parts by chemical and/or mechanical means, final machining of the said body, if needed, to meet the specifications of the epitaxial deposition process.

272. The chamber body of claim 271, wherein the finished body is subjected to thin film deposition such as chemical vapor deposition, plasma enhanced deposition, or other suitable deposition method for better finish on the inside and outside.

273. The chamber body of any of the preceding claims 262 to 266, wherein the epitaxial chamber comprises single part or upper and lower parts made by casting or cold or hot pressing to shape to shape the material, machining the parts, purifying the said body at a certain temperature by immersing it in a chemically reactive gas, plasma or liquid for certain period of time, sintering the said body at appropriate temperature determined by its composition, joining the parts by chemical and/or mechanical means, final machining of the said body, if needed, to meet the specifications of the epitaxial deposition process.

274. The chamber body of claim 273, wherein the finished body is subjected to thin film deposition such as chemical vapor deposition, plasma enhanced deposition, or other suitable deposition method for better finish on the inside and outside.

275. The chamber body of any of the preceding claims 262 to 266, wherein the epitaxial chamber comprises one part or upper and lower parts made by cold or hot pressing of a block of the material, machining the chamber, purifying the said body at a certain temperature by immersing it in a chemically reactive gas, plasma or liquid for certain period of time, sintering the said body at appropriate temperature determined by its composition, joining the parts by chemical and/or mechanical means, final machining of the said body, if needed, to meet the specifications of the epitaxial deposition process.

276. The chamber body of claim 275, wherein the finished body is subjected to thin film deposition such as chemical vapor deposition, plasma enhanced deposition, or other suitable deposition method for better finish on the inside and outside.

277. The chamber body of any of the preceding claims 262 to 266, wherein the epitaxial chamber comprises one part or upper and lower parts made by cold or hot extrusion of a block or a desired shape of the material, machining the chamber, purifying the said body at a certain temperature by immersing it in a chemically reactive gas, plasma or liquid for certain period of time, sintering the said body at appropriate temperature determined by its composition, joining the parts by chemical and/or mechanical means, final machining of the said body, if needed, to meet the specifications of the epitaxial deposition process.

278. The chamber body of claims 277, wherein the finished body is subjected to thin film deposition such as chemical vapor deposition, plasma enhanced deposition, or other suitable deposition method for better finish on the inside and outside.

279. The chamber body of any of the preceding claims 262 to 266, wherein the epitaxial chamber comprises one part or upper and lower parts made by plasma spraying of the material, and forming a chamber to a desired shape, machining the chamber, purifying the said body at a certain temperature by immersing it in a chemically reactive gas, plasma or liquid for certain period of time, sintering the said body at appropriate temperature determined by its composition, joining the parts by chemical and/or mechanical means, final machining of the said body, if needed, to meet the specifications of the epitaxial deposition process.

280. The chamber body of claim 279, wherein the finished body is subjected to thin film deposition such as chemical vapor deposition, plasma enhanced deposition, or other suitable deposition method for better finish on the inside and outside.

281. The chamber body of any of the preceding claims 262 to 266, wherein the epitaxial chamber comprises one part or upper and lower parts made by spraying of organic or inorganic based slurry of the material and forming a chamber to a desired shape, machining the chamber, purifying the said body at a certain temperature by immersing it in a chemically reactive gas, plasma or liquid for certain period of time, sintering the said body at appropriate temperature determined by its composition, joining the parts by chemical and/or mechanical means, final machining of the said body, if needed, to meet the specifications of the epitaxial deposition process.

282. The chamber body of claim 281, wherein the finished body is subjected to thin film deposition such as chemical vapor deposition, plasma enhanced deposition, or other suitable deposition method for better finish on the inside and outside.

283. The chamber body of any of the preceding claims 262 to 282, wherein the chamber comprises two separate halves joined at one plane followed by final machining.

284. The chamber body of any of the preceding claims 262 to 282, wherein the chamber comprises a single body machined from a solid block material.

285. The chamber body of any of the preceding claims 262 to 282, wherein the chamber comprises a single body made by method of plasma spraying followed by final machining.

286. The chamber body of any of the preceding claims 262 to 282, wherein the chamber comprises a single body made by method of slurry spraying.

287. The chamber body of any of the preceding claims 262 to 282, wherein the chamber comprises a single body machined by method of casting, forging or extrusion followed by sintering and final machining.

288. The chamber body of any of the preceding claims 262 to 287, wherein the chamber has a vacuum, reduced pressure or desired pressure chamber.

289. The chamber body of any of the preceding claims 262. to 288, wherein the chamber has a liner for a vacuum, reduced pressure or desired pressure chamber for wafer processing applications.

290. The chamber body of any of the preceding claims 262 to 289, wherein the chamber is made of modular pieces stacked on top of each other or bonded by mechanical or chemical means.

291. The chamber body of any of the preceding claims 262 to 290, further comprising an optical window, wherein the optical window is from same or suitable material stacked on the chamber or bonded by mechanical or chemical means.

292. The chamber body of any of the preceding claims 262 to 291, wherein the chamber has one or more optical windows depending on the process requirements.

293. The chamber body of any of the preceding claims 262 to 292, further comprising a gas delivery system for delivering process and inert gases into the chamber attached to the chamber or to the chamber wall.

294. The chamber body of any of the preceding claims 262 to 293, further comprising gas delivery members exposed to the process atmosphere made from the chamber material or chamber lining material.

295. The chamber body of any of the preceding claims 262 to 294, further comprising a wafer delivering/removing arm to/from the chamber made from the chamber material or chamber lining material.

296. The chamber body of any of the preceding claims 262 to 295, further comprising a susceptor and a member that either holds the wafer or surrounds the wafer from the sides, the top or the bottom, as required by the process made from the chamber material or chamber lining material.

297. The chamber body of any of the preceding claims 262 to 296, further comprising a reduced pressure chamber surrounding the epitaxial/CVD chamber made in full or partially from material selected from a group consisting of silicon, silicon compound comprising at least one silicon atom, silicon and germanium, SiₓGe₁₋ₓ solid solution, silicon and silicon carbide Siₓ(SiC)₁₋ₓ, silicon and silicon dioxide Sₓ(SiO₂)₁₋ₓ, silicon and any ceramic, silicon and any oxide Sₓ(Oxide)₁₋ₓ, silicon and any metal SiₓM₁₋ₓ, silicon and any alloy SiₓA₋ₓ, any combination between themselves, or made from composite material, wherein 0≦x≦1.

298. The chamber body of any of the preceding claims 262 to 297, further comprising a body, an optical window for wafer radiation and at least one opening for wafer and gas delivery/removal.

299. The chamber body of any of the preceding claims 262 to 298, further comprising an outer chamber of vacuum, reduced pressure or desired pressure as required by the process.

300. The chamber body of any of the preceding claims 262 to 299, wherein the chamber comprises one or more optical windows depending on the process requirements.

301. The chamber body of any of the preceding claims 262 to 300, wherein the chamber has gas delivery system for delivering process and inert gases into the chamber attached to the chamber or to the chamber wall.

302. A single wafer processing system for CVD, epitaxial deposition, thin film deposition/removal or any other wafer processing for a chip comprising a vacuum vessel with cooled or not cooled chamber wall with single or double wall, connected directly or through at least one gate valve to a chamber with multistage wafer handling mechanism for wafer delivery/removal, a shield surrounding the wafer processing area, process and inert gas delivery system with all respective valves attached to the chamber and having a delivery tube extending into a wafer area, vacuum pumping system connected to the chamber, inside and/or outside heater directing heat into the process area employing one or more members made from material selected from a group consisting of silicon, silicon compound comprising at least one silicon atom, silicon and germanium, SiₓGe₁₋ₓ solid solution, silicon and silicon carbide Sₓ(SiC)₁₋ₓ, silicon and silicon dioxide Siₓ(SiO₂)₁₋ₓ, silicon and any ceramic, silicon and any oxide Siₓ(Oxide)₁₋ₓ, silicon and any metal SiₓM₁₋ₓ, Silicon and any alloy SiₓA₁₋ₓ, any combination between themselves, or made from composite material, wherein 0≦x≦1, employing at least one epitaxial chamber.

303. Process for fabrication of silicon/silicon alloy/composite/silicon compound having at least one silicon atom members comprising processing high purity quartz or fused silica material and forming different structures for processing wafers.

304. The process of claim 303, wherein the forming further comprises making silicon boats having desired mechanical properties.

305. The process of claim 304, wherein the processing comprises forging, extrusion, plasma and hot substrate powder deposition, slurry spray and slurry casting, silicon/silicon alloy/composite/silicon compound having at least one silicon atom casting and directional solidification for the fabrication of the members.

306. The process of any of the preceding claims 303 to 305, wherein the processing comprises silicon/silicon alloy/composite/silicon compound having at least one silicon atom powder pressing and/or forging and extrusion.

307. The process of any of the preceding claims 303 to 306, wherein the forming comprises fabrication of epitaxial reactors, chemical vapor deposition (CVD) chambers, CVD chamber liners, tubing, and combinations thereof.

308. The process of any of the preceding claims 303 to 306, wherein the forming comprises fabrication of silicon/silicon alloy/composite/silicon compound having at least one silicon atom members selected from a group consisting of wafer boats for horizontal and vertical wafer processing furnaces and deposition chambers, epitaxial reactors, lining for CVD chambers, epitaxial reactors and other wafer processing tools, tubing having any form or cross section shape, and combinations thereof.

309. The process of any of preceding claims 303 to 308, wherein the processing comprises pressing silicon/silicon alloy/composite/silicon compound having at least one silicon atom material at room temperature or at an elevated temperature in vacuum or in a controlled atmosphere, outgassing, removing oxygen, nitrogen, water vapor and other undesired gases before/during/after pressing of the material.

310. The process of any of the preceding claims 303 to 309, wherein the pressing comprises pressing to a near shape of a part being fabricated.

311. The process of any of the preceding claims 303 to 309, wherein the pressing comprises pressing into a raw material for further processing into desired members.

312. The process of any of the preceding claims 303 to 311, wherein the material comprises a powder selected from a group consisting of silicon, silicon compound having at least one silicon atom, silicon and germanium, silicon and metal, silicon and silicon carbide, silicon and ceramic, silicon and a suitable element or compound and combinations thereof.

313. The process of any of the preceding claims 303 to 312, wherein processing the material comprises providing silicon powder, silicon compounds having at least one atom of silicon, silicon based alloys or composites having a desired grain size in a pressing chamber.

314. The process of any of the preceding claims 303 to 313, wherein the processing further comprises treating with gas treatment and/or vacuuming the residual gas and then pressing the material.

315. The process of any of the preceding claims 303 to 314, wherein the processing comprises pressing at a temperature as low as room temperature or as high as a softening point of the lowest melting point constituent.

316. The process of any of the preceding claims 303 to 315, wherein the processing further comprises sintering the pressed part in vacuum or in appropriate gaseous atmosphere and fabricating very dense materials with predetermined hardness.

317. The process of claim 316, further comprising tailoring various parts for various applications by adjusting a grain size of the material, wherein smaller grain sizes are used for making parts with higher fracture strength and vice-versa.

318. The process of any of the preceding claims 303 to 317, further comprising machining the parts made before the sintering, sintering, and after the sintering allowing the parts to yield near shape for using as sintered parts or for subjecting sintered parts to a further final machining.

319. The process of any of the preceding claims 303 to 318, wherein the processing comprises processing at pressures of up to 800,000 psi or higher.

320. The process of any of the preceding claims 303 to 319, wherein the processing comprises processing at temperatures of suitable for the material during pressing and sintering and varying the temperatures corresponding to a composition of the material.

321. The process of any of the preceding claims 303 to 320, wherein the processing comprises processing at temperatures between 300° C. and 1350° C.

322. The process of any of the preceding claims 303 to 320, wherein the processing comprises processing at temperatures up to about 300° C. and greater than about 1350° C. corresponding to the material being processed and desired properties of the members.

323. The process of any of the preceding claims 303 to 322, wherein the forming comprises press-shaping solid silicon of single crystal or polycrystalline material into various parts, heating the silicon to a desired temperature and obtaining appropriate plastic properties.

324. The process of claim 323, wherein the press-shaping comprises shaping by forging or extrusion of the silicon/silicon alloy/composite/silicon compound having at least one silicon atom material.

325. The process of claims 303 and 324, wherein the pressing and shaping of the material is done before, during or after sintering of the material.

326. The process of any of the preceding claims 303 to 325, further comprising selecting a desired material corresponding to a plasticity of the material for determining grain size and fracture strength.

327. The process of any of the preceding claims 303 to 326, wherein the pressing comprises several steps of hot pressing the material.

328. The process of any of the preceding claims 303 to 327, wherein the processing comprises extrusion followed by forging and/or high pressure annealing.

329. The process of any of the preceding claims 303 to 305, wherein the shaping of the material further comprises imbedding stronger material in the part being made for reinforcement purposes.

330. The process of claim 329, wherein the imbedding comprises providing a strong layer within the part or forming the stronger layer on an outer or inner surface of the part and fabricating parts having desired strength pattern.

331. Member forming process comprising providing plasma heated or not heated silicon powder material or non plasma heated or non-heated silicon powder material, introducing the material into a chamber, directing the material towards a heated substrate and depositing on the substrate.

332. The process of claim 331, wherein the chamber is a vacuum, low pressure, normal pressure or high-pressure chamber.

333. The process of claim 332, wherein the powder deposition comprises depositing silicon only, or silicon and other material particles and reinforcing silicon structure without changing chemical behavior or material particles that change the properties of silicon and forming a silicon alloy or solid solution.

334. The process of any of the preceding claims 331 to 333, wherein the material is selected from a group consisting of Ge, SiₓG₁₋ₓ, SiC, silicon based materials, silicon compound having at least one silicon atom, ceramics, suitable elements or compounds and doping and/or reinforcing the material.

335. The process of any of the preceding claims 331 to 334, wherein the depositing comprises depositing layers corresponding to a temperature of the substrate, wherein the deposited layers have different densities and thicknesses, sintering the layers and forming very dense material having desired fracture strengths.

336. The process of any of the preceding claims 331 to 335, further comprising injecting the non-plasma heated powder or not heated powder material in the chamber and directing towards a hot substrate within a heated or non-heated controlled atmosphere or vacuum chamber.

337. The process of any of the preceding claims 331 to 336, further comprising heating the powder material to a desired temperature on its way to and from the substrate, adhering grains of the material to the substrate and/or other previously deposited grains on the substrate and forming a deposited body.

338. The process of any of the preceding claims 331 to 337, wherein a density of the deposited body is proportional to grain size, grain temperature at impact and substrate temperature.

339. The process of any of the preceding claims 331 to 338, wherein the member is a silicon/silicon alloy/composite/silicon compound having at least one silicon atom member having shapes selected from a group consisting of rod, tube having any cross-section and shape, any chamber looking type shape with one or more gates, and combinations thereof.

340. The process of any of the preceding claims 331 to 339, wherein the substrate is heated up to a softening point of silicon material.

341. The process of any of the preceding claims 331 to 340, wherein an optimal temperature is between about 800° C. to about 1350° C.

342. The process of any of the preceding claims 331 to 341, wherein the temperatures are less than about 800° C. and more than about 1350° C.

343. The process of any of the preceding claims 331 to 342, wherein the sintering of the silicon/silicon alloy/composite/silicon compound having at least one silicon atom members is done in situ, or after machining, shaping or joining of the members with other parts made by the same or different process.

344. The process of any of the preceding claims 331 to 343, wherein the sintering temperature corresponds to chemical composition of the parts and their applications.

345. Chemical vapor deposition (CVD) process comprising deposition of silicon and/or silicon/composite and/or silicon alloy and/or silicon compound having at least one silicon atom materials on a substrate, reinforcing deposited layers without changing the chemical behavior of a surface of interest and forming members for various applications.

346. The process of claim 345, wherein the deposition of the silicon/silicon alloy/composite/silicon compound having at least one silicon atom material on the substrate comprises providing a suitable substrate having a sticking coefficient to deposited material.

347. The process of claim 46, wherein the material is selected from a group consisting of silicon nitrides, graphite, metal silicates, ceramics, silicon, silicon compound having at least one silicon atom, and substances suitable as substrate for particular applications, and combinations thereof.

348. The process of any of the preceding claims 345 to 347, wherein the deposition comprises depositing the material at variable temperatures of the substrate and variable pressures during the deposition process.

349. The process of any of the preceding claims 345 to 348, wherein the deposited layers have initial thicknesses that after sintering results in very dense material having desired thickness for a particular application.

350. The process of any of the preceding claims 345 to 349, wherein the members are silicon/silicon alloy/composite/silicon compound having at least one silicon atom members having shapes selected from a group consisting of rod, tube having desired cross-section, shape and size, plate or any wafer processing chamber suitable type shape, having one or more gates leading inside the chamber.

351. Fabrication process for forming members comprising mixing a powder with a high purity liquid chemical compound and forming a slurry, spraying or casting the slurry, and forming a desired body.

352. The process of claim 351, wherein the spraying comprises depositing the slurry on a substrate that rotates and/or translates.

353. The process of claim 352, wherein the substrate comprises any material that does not react with or contaminate the slurry.

354. The process of claim 353, further comprising either incorporating the material in the fabricated body or curing and removing liquids and separating the material during or after deposition of the slurry.

355. The process of any of the preceding claims 351 to 354, further comprising roughly machining the cured articles before a bake-out process is implemented.

356. The process of any of the preceding claims 351 to 355, further comprising implementing a bake out process and completely removing chemical substances such as binders and sintering the silicon/silicon alloy/composite powder/silicon compound having at least one silicon atom made member.

357. The process of any of the preceding claims 351 to 356, further comprising machining the members into desired shapes following the bake-out process.

358. The process of any of the preceding claims 351 to 357, wherein the slurry deposition and/or casting is conducted in vacuum or controlled gas atmosphere chamber employing one or more heaters.

359. The process of any of the preceding claims 351 to 358, wherein the curing and sintering is conducted in the same or in a different chamber.

360. The process of any of the preceding claims 351 to 359, wherein the silicon/silicon alloy/composite/silicon compound having at least one silicon atom member have shapes of rod, round tube, rectangular tube, plate or any wafer processing chamber suitable type shape.

361. Fabrication process comprising casting to shape silicon/silicon alloy/composite/silicon compound comprising at least one silicon atom material or re-melting and casting solid silicon and forming various made parts.

362. The process of claim 361, further comprising providing a high purity mold made from easily removable material that does not react with silicon/silicon alloy/composite/silicon compound, filling the mold with shot, powder or small chunks of the material to be melted.

363. The process of claim 362, wherein the material for casting is melted in a separate container and transferred into the mold after melting.

364. The process of claim 363, further comprising removing oxygen, nitrogen, water vapor, and other contaminants before the melting process.

365. The process of claim 364, wherein the forming the member comprises forming silicon/silicon alloy/composite/silicon compound member having a shape selected from a group consisting of rod, round tube, tube or any other shape or form.

366. Fabrication process comprising gelcasting silicon/silicon alloy/composite/silicon compound having at least one silicon atom material and forming a body.

367. The process of claim 366, further comprising converting the material in powder having desired grain size.

368. The process of claim 367, further comprising suspending the powder in a monomer solution which is polymerized in a mold to form a rigid polymer/solvent gel.

369. The process of any of the preceding claims 366 to 368, further comprising adding organic or inorganic substances to the powder/polymer binder, triggering a polymerization process.

370. The process of any of preceding claims 366 to 369, wherein the polymerization process is triggered at desired process conditions.

371. The process of any of the preceding claims 366 to 370, wherein the process comprises up to 10-20 weight % polymer.

372. The process of any of the preceding claims 366 to 371, wherein the percentage is as low as few weight percent and over 20 weight percent.

373. The process of any of the preceding claims 366 to 372, further comprising drying and removing a solvent portion after removing the fabricated part from the mold.

374. The process of any of the preceding claims 366 to 372, further comprising wherein the solution is aqueous or non-aqueous.

375. The process of claim 374, wherein the non-aqueous solution comprises 50-55 volume % of powder with balance being a dispersion solution.

376. The process of any of preceding claims 366 to 375, wherein the solution comprises about 10% dispersant such as Rohm & Haas Triton X-100, or N-100 Dupont dibasic ester (DBE) or ICI Americas Solsperse 2000 in dibutil phtalate (DBP) and 90% gelcasting premix, wherein the premix includes 10-30 volume % of monomers such as trifunctional trimethilpropane triacrylate (TMPTA) and difunctional 1,6 hexanediol diacrilate (HDODA) from Hoechst Celanese, 0.5 to 10 volume % of dybenzoil peroxide initiator with the rest being either DBA, DBP or other suitable solvent.

377. The process of any of preceding claims 366 to 376, further comprising hardening of the material mass in the mold, spraying onto a substrate having desired process temperature, and fabricating the member,

378. The process of any of preceding claims 366 to 377, wherein the spraying comprises spraying in vacuum or desired gaseous atmosphere.

379. The process of any of the preceding claims 366 to 378, wherein the spraying comprises spraying the slurry or spraying various components onto the substrate, mixing, reacting and hardening into the desired shape.

380. The process of any of preceding claims 366 to 379, wherein the fabrication comprises continuous feeding onto a beltline type apparatus.

381. The process of any of preceding claims 366 to 380, further comprising hardening, drying and sintering as part of the continuous process.

382. The process of any of the preceding claims 366 to 381, wherein the feed comprises already made mixture of the material.

383. The process of any of the preceding claims 366 to 382, wherein the feed comprises mixing material at a feeding point.

384. Fabrication process for fabricating large size silicon/silicon alloys/composites/silicon compound having at least one silicon atom material into a member by directional solidification in an open or closed mold/container containing the material to be solidified.

385. The process of claim 384, wherein the member fabricated is a plate, rod, tube or any other shape.

386. The process of claim 385, wherein the process is conducted in a vacuum or controlled atmosphere chamber.

387. The process of any of the preceding claims 384 to 386, further comprising removing oxygen, nitrogen, water vapor, and other possible contaminants are taken before melting the material.

388. The process of any of the preceding claims 384 to 387, wherein the member made may has shapes selected from a group consisting of plate, rod, tube or any other shape or form.
